(19) United States
(12) Patent Application Publication
(10) Pub. No.: US 2018/0218286 A1
(43) Pub. Date: Aug. 2, 2018

(54) GENERATING MODELS TO MEASURE PERFORMANCE OF CONTENT PRESENTED TO A PLURALITY OF IDENTIFIABLE AND NON-IDENTIFIABLE INDIVIDUALS

(71) Applicant: Facebook, Inc., Menlo Park, CA (US)

(72) Inventors: Goran Predovic, Redmond, WA (US); Liang Xu, Bellevue, WA (US); Chaochao Cai, Bellevue, WA (US)

(21) Appl. No.: 15/421,060

(22) Filed: Jan. 31, 2017

(51) Int. Cl. G06N 99/00; G06F 17/30

(52) U.S. Cl. CPC G06N 99/005; G06F 17/30536; G06F 17/30365

(57) ABSTRACT

An online system measures performance of content presented to a plurality of identifiable and non-identifiable individuals based on matching user identifying information included in data describing presentation of the content and data describing performance of an action associated with the content. To reduce measurement inaccuracy resulting from incomplete matching of user identifying information associated with non-identifiable individuals, the online system generates models to extrapolate data describing an amount of unique individuals presented with the content, an amount of unique individuals who performed an action associated with the content, and an amount of unique individuals who performed the action associated with the content attributable to presentation of the content by a content publisher. The models are applied to data collected by the online system describing presentation of the content and performance of actions associated with the content. Metrics describing performance of the content are generated based on the models.

### BACKGROUND

This disclosure relates generally to online systems, and more specifically to measuring performance of content presented to users by multiple online systems.

Online systems, such as social networking systems, allow users to connect to and to communicate with other users of an online system. Users may create profiles on an online system that are tied to their identities and include information about the users, such as interests and demographic information. The users may be individuals or entities such as corporations or charities. Online systems allow users to easily communicate and to share content with other online system users by providing content to an online system for presentation to other users. Content provided to an online system by a user may be declarative information provided by a user, status updates, check-ins to locations, images, photographs, videos, text data, or any other information a user wishes to share with additional users of the online system. An online system may also generate content for presentation to a user, such as content describing actions taken by other users on the online system.

Additionally, many online systems commonly allow publishing users (e.g., businesses) to sponsor presentation of content on an online system to gain public attention for a publishing user's products or services or to persuade other users to take an action regarding the publishing user's products or services. Content for which the online system receives compensation in exchange for presenting to users is referred to as “sponsored content.” Many online systems receive compensation from a publishing user for presenting online system users with certain types of sponsored content provided by the user. Frequently, online systems charge a publishing user for each presentation of sponsored content to an online system user or for each interaction with sponsored content by an online system user. For example, an online system receives compensation from a publishing user each time a content item provided by the publishing user is displayed to another user on the online system or each time another user is presented with a content item on the online system and interacts with the content item (e.g., selects a link included in the content item), or each time another user performs one or more particular actions after being presented with the content item (e.g., visits a website or physical location associated with the user who provided the content item).

An online system that presents content received from a publishing user may provide the publishing user with various metrics describing certain actions performed by individuals after being presented with the content to describe the effectiveness of the content at eliciting the actions. For example, an online system presents users with a content item and determines a number of users who select a link included in the content item or a number of times the users visit a website associated with the content item during a particular time interval based on information received from client devices on which users interact with the content item. Based on the number of users who selected a link included in the content item or a number of times the users visited the website associated with the content item after being presented with the content item, the online system determines a metric and includes the metric in a report which describes the content item's effectiveness and is provided to a publishing user associated with the content item.

Metrics determined by an online system may also describe effectiveness of content presentation by the online system and/or various third party systems that present the content item. For example, an online system determines a metric describing certain actions performed by individuals on a particular website after being presented with a content item by various content publishers including the online system based on collected data describing the actions and presentations of the content item. Based on the collected data, the online system may determine a metric describing an amount of the actions attributable to presentation of the content item by each of the content publishers. For example, the online system determines a number of individuals who performed a particular action associated with a content item after being presented with the content item by various content publishers including the online system, and determines a percentage of the performed actions attributable to presentation of the content item by each content publisher.

Online systems commonly determine metrics describing performance of content and performance of content presentation by various content publishers by matching user identifying information included in various types of data collected by an online system. For example, an online system receives data describing presentation of content to individuals associated with online system user identifiers and determines a number of the individuals presented with the content by computing a number of unique online system user identifiers included in the data. Similarly, an online system receives data describing actions performed by individuals associated with online system user identifiers and determines a number of individuals who performed the action by computing a number of unique online system user identifiers included in the data. As yet another example, an online system may determine a number of individuals who performed an action after being presented with a content item by matching unique user identifiers associated with individuals presented with the content item and user identifiers associated with individuals who performed the action. By computing a number of matching identifiers, the online system may determine a number of individuals who were presented with the content item and performed the action.

However, while data used by an online system to determine metrics often includes user identifying information associated with some individuals presented with content or who performed an action associated with the content, user identifying information is often not associated with every presentation of the content or every action. For example, the collected data may not include user identifying information associated with individuals who are not online system users or who are not logged into the online system when performing an action or being presented with content. Additionally, even if the collected data includes user identifying information associated with every individual presented with content or who performed a certain action, the user identifying information may be inconsistent or incomplete. For example, an individual presented with a content item on a first client device who later performs an action associated with the content item on a second client device may be associated with two different types of user identifying information; user identifying information associated with the first client device and user identifying information associated with the second client device.

If data used by an online system to determine metrics includes incomplete or inconsistent user identifying information, metrics based on the data may be incomplete or inaccurate. For example, if a metric is based on a number of user identifiers associated with individuals presented with a content item matching user identifiers associated with individuals who performed an action, the metric may be inaccurately low if the data used to determine the metric includes user identifiers associated with fewer than all of the individuals presented with the content item who performed the action. Additionally, data used to determine metrics which includes incomplete or inconsistent user identifying information may cause an online system to determine metrics which are biased in favor of content presentation by the online system. For example, an online system determining a metric based on data including incomplete user identifying information may identify a higher percentage of individuals presented with content by the online system who later performed a particular action based on information maintained by the online system than a percentage of individuals presented with the content by a third party system. As a result, the metric may over report a percentage of individuals presented with content by the online system who performed the action and under report individuals presented with content by a third party system who performed the action. Hence, an online system may generate metrics that inaccurately describe performance of content and content presentation by the online system and various third party systems if the metrics are based on presentation of content to individuals not associated with user identifying information.

### SUMMARY

An online system determines metrics describing performance of content presented to a plurality of identifiable and non-identifiable individuals by various entities based on presentation features describing presentation of a content item by the various entities and conversion features describing occurrences of certain events associated with the content item. The plurality of individuals presented with the content item includes a group of online system users who the online system is able to identify or otherwise distinguish from other individuals presented with the content item (e.g., based on stored information maintained by the online system) and individuals who the online system is not able to identify. In some embodiments, the content item is an organic content item, such as a user generated story, while in other embodiments, the content item is a sponsored content item (i.e., a content item for which an entity receives compensation in exchange for presenting to an individual). The various entities that may present the content item to the plurality of individuals include various content publishers associated with a website and/or an application for presenting electronic content to target audiences via client devices associated with members of the audiences. For example, the entities include the online system and one or more content publishers external to the online system that present sponsored and organic content to a plurality of individuals including users of the online system via certain websites.

The occurrences of certain events associated with a content item include conversion events (or “conversions”), which comprise certain events or actions associated with the content item that are performed by individuals (e.g., in response to being presented with the content item). For example, conversions include a visit by an individual to a location associated with a content item or a purchase by the individual of a product or service associated with the content item. Features associated with presentation of the content item (“presentation features”) and with conversions (“conversion features”) describe different aspects of presentation of the content item to different individuals and performance of conversions associated with the content item. For example, a presentation feature describes a client device on which a content item was presented and a conversion feature describes a client device on which a conversion occurred, which may be the same or different client device.

In various embodiments, metrics determined by the online system based on presentation and conversion features may describe an amount of individuals presented with a content item by one or more content publishers, an amount of individuals who performed a conversion associated with the content item, and an amount of conversions attributable to presentation of the content item by a particular content publisher. For example, the online system determines associations between presentation features and conversion features included in data collected by the online system and associates certain presentation features with certain conversion features. Based on an amount of associated presentation features and conversion features included in the collected data of the preceding example, the online system determines a metric describing an amount of conversions performed by a group of individuals attributable to presentation of the content item by a specified content publisher. A metric describing an amount of conversions attributable to presentation of a content item by one or more content publishers may be expressed in terms of each content publisher's share (e.g., percentage) of conversions attributable to presentation of the content item by the content publisher, in some embodiments. Hence, metrics determined by the online system describe performance of organic and/or sponsored content presented to a plurality of individuals including online system users by entities other than, or in addition to, the online system based on features associated with presentation of the content item to the plurality of individuals and features associated with actions performed by certain individuals.

The metrics determined by the online system are based in part on received presentation data describing presentation of the content item by one or more content publishers to a plurality of individuals including a group of online system users. For example, the online system receives a table of data describing various aspects of presentation of a content item to online system users and additional individuals who are not online system users from a content publisher that presented the content item. In some embodiments, the presentation data is received from a content publisher that presented the content item, while in other embodiments, the presentation data is received from a third party system, such as a data analytics provider, that collects and reports the data to the online system. The presentation data may also be communicated to the online system by a client device or an application executing on a client device presenting the content item to an individual in response to instructions included in the content item that cause the client device or application to communicate the data to the online system, in some embodiments. Presentation data received by the online system includes information identifying a content item presented to a plurality of individuals, one or more content publishers that presented the content item, a time associated with each presentation of the content item, presentation features associated with each presentation of the content item, and user identifying information associated with some of the individuals presented with the content item.

Presentation features included in the presentation data identify values of attributes associated with each presentation of the content item by a content publisher. In various embodiments, the presentation features identify values of: a web browser on which the content item was presented to an individual (e.g., Safari, Chrome, Microsoft Edge, etc.), a cookie setting associated with the web browser on which the content item was presented to the individual (e.g., a high, medium or low privacy setting), an operating system operating on a client device on which the content item was presented to the individual (e.g., Windows, Mac OS, etc.), and a type of client device on which the content item was presented to the individual (e.g., mobile device, desktop computer, etc.). Since presentation features identify values of attributes associated with each presentation of the content item, individuals presented with the content item more than once may be associated with more than one set of presentation feature values. For example, presentation features describing multiple presentations of a content item to a single unique individual identify multiple client devices and operating systems if the individual was presented with the content item on different client devices executing different operating systems. Hence, the presentation data may include presentation features associated with multiple presentations of the content item to a single unique individual.

The presentation data also includes user identifying information associated with a plurality of users of the online system presented with the content item. For example, the presentation data includes an online system user identifier for each user who was logged into the online system when the content item was presented to the user. In various embodiments, the user identifying information includes a user identifier, a browser identifier, a client device identifier and/or any other suitable information from which the online system may identify or distinguish a user presented with the content item. For example, the online system determines an identity of a user presented with the content item by comparing a user identifier included in the presentation data with information maintained by the online system describing an identify of the user. As another example, the online system distinguishes between different users presented with the content item by distinguishing unique user identifiers included in the presentation data.

While the presentation data includes user identifying information associated with some online system users presented with the content item, the presentation data also describes presentation of the content item to individuals who are not online system users or for whom user identifying information is not included in the presentation data. For example, the presentation data does not include user identifying information associated with individuals who are not online system users or who are online system users but were not logged into the online system when presented with the content item. Hence, the presentation data describes presentation of the content item to identifiable users of the online system, non-identifiable users of the online system and individuals who are not users of the online system.

To identify presentation data describing presentation of the content item to a unique group of individuals by a specified content publisher, the online system determines a group of individuals presented with the content item by the content publisher based on a set of presentation features and user identifying information included in the presentation data. For example, to determine a “reach” of the content item, the online system predicts a composition of a group of individuals such that each individual member of the group is a unique individual who was presented with the content item by the content publisher. Based on the user identifying information included in the presentation data, the online system identifies a group of online system users presented with the content item by the content publisher. For example, the online system identifies a group of online system users associated with user identifying information included in the presentation data.

From the identified group of online system users, the online system selects a sample subgroup of online system users having at least a threshold measure of similarity to the plurality of individuals presented with the content item by the content publisher. In some embodiments, the online system identifies a sample subgroup of users associated with a frequency distribution of presentation feature values having at least a threshold measure of similarity to a frequency distribution of presentation feature values described by the presentation data. In various embodiments, the online system may use one or more alternative methods of sampling to select the subgroup of users from the group of users.

Based on the presentation data associated with the subgroup of users, the online system identifies presentation feature values associated with each user of the subgroup and uses the values to train a machine learned model (a “presentation model”) used by the online system to determine the group of individuals presented with the content item by the content publisher. In various embodiments, the online system uses one or more machine learning techniques to determine associations between the set of values and to generate weights for each value and/or different combinations of values. Two or more presentation feature values are associated with each other if the values are associated with the same user of the subgroup of users. Weights generated by the online system and included in the presentation model describe strengths of the determined associations between each presentation feature value or combination of values. For example, a numerical weight generated for a particular combination of presentation feature values is proportional to a strength of the determined association between the values.

Based on a strength of the determined associations between each presentation feature value, the presentation model predicts a likelihood that presentations of the content item associated with certain combinations of the values are associated with a single unique individual. For example, if a weight of 0.9 is generated for a combination of presentation feature values determined to be strongly associated with each other, the presentation model predicts that, for every ten occurrences of the combination of values in the presentation data, nine unique individuals were presented with the content item by the content publisher. As another example, if the online system generates a weight of 0.1 for a combination of presentation feature values determined to be weakly associated, the presentation model predicts that, for every ten occurrences of the combination of values in the presentation data, one unique individual was presented with the content item by the content publisher.

The online system applies the presentation model to the values of the presentation features described by the received presentation data to determine the group of individuals and presentation feature values associated with the group of individuals. For example, the presentation model is configured to receive, as input, information identifying the content item, a content publisher that presented the content item and values of presentation features associated with presentation of the content item by the content publisher. Based on the input, the presentation model predicts likelihoods that certain combinations of the values are associated with unique individuals. Based on the determined likelihoods that certain combinations of the presentation feature values are associated with unique individuals, the online system determines the group of individuals and associates the combinations of presentation feature values associated with each unique individual with the group of individuals. For example, based on a number of certain presentation feature values included in the presentation data predicted to be associated with unique individuals, the online system determines a number of unique individuals included in the group and associates the presentation feature values with the group.

In various embodiments, the online system generates one or more metrics describing the group of individuals and provides the metric to an entity or user of the online system associated with the content item. For example, the online system generates a metric describing a number of individuals presented with the content item by the content publisher and provides the metric to a publishing user associated with the content item. In the previous example, the number of individuals presented with the content item by the content publisher corresponds to the number of individuals in the determined group of individuals, which may differ from the number of presentations of the content item described by the presentation data. Hence, application of the presentation model to the received presentation data allows the online system to determine 310 a group of identifiable and non-identifiable individuals presented with the content item by the content publisher and to determine metrics describing presentation of the content item to the group of individuals.

To identify conversions associated with the content item, the online system retrieves conversion data describing occurrences of one or more events associated with the content item (e.g., during a specified time interval). As described above, the one or more events include conversions comprising certain actions associated with the content item performed by individuals. In some embodiments, the online system retrieves conversion data from information stored at the online system describing actions associated with the content item performed by users of the online system during a specified time period, while in other embodiments, conversion data is received from a publishing user of the online system associated with the content item. In some embodiments, the conversion data is received from a trusted third party system that collects and reports conversion data associated with various content items and publishing users to the online system. In yet other embodiments, the conversion data is communicated to the online system by a client device or an application executing on a client device on which a conversion was performed. For example, instructions included in content presented by the client device or application with which an individual interacts to perform a conversion cause the client device or application to communicate conversion data to the online system. Information describing conversions included in the conversion data may include a conversion type identifier that identifies a type of action associated with a content item performed by an individual, a content item identifier that identifies the content item, a publishing user identifier that identifies a publishing user associated with the content item, and a time associated with the action, in some embodiments.

In various embodiments, the conversion data also includes a set of conversion features associated with each occurrence of an action described by the conversion data. Conversion features included in the conversion data identify values of attributes associated with each occurrence of a conversion. In various embodiments, conversion features identify values of a web browser on which the conversion occurred, an operating system operating on a client device on which the conversion occurred, a type of client device or devices on which the conversion occurred, and a cookie setting associated with a web browser on which the conversion occurred. Since conversion features identify values of attributes associated with each occurrence of a conversion, individuals who performed a conversion more than once may be associated with more than one set of conversion feature values. For example, conversion features describing multiple occurrences of a conversion performed by a single unique individual identify multiple web browsers and web browser cookie settings if the individual performed a conversion on different web browsers associated with different cookie settings. Hence, the conversion data may include conversion features associated with multiple conversions performed by single unique individuals.

The conversion data also includes user identifying information associated with some users of the online system, including users who are members of the determined group of individuals presented with the content item. The user identifying information allows the online system to distinguish or determine an identity of certain users who performed conversions described by the conversion data. For example, conversion data describing conversions performed by online system users who were logged into the online system when performing a conversion includes an online system user identifier associated with the user, allowing the online system to distinguish the user from other users who performed a conversion described by the conversion data. While the conversion data includes user identifying information from which the online system may identify certain users who performed a conversion, the conversion data also describes conversions by individuals who are not online system users or for whom user identifying information is not included in the presentation data. For example, the conversion data includes information describing conversions that are not associated with user identifying information from which the online system may identify an individual that performed the conversion. Hence, the conversion data describes conversions performed by identifiable online system users, non-identifiable online system users, and individuals who are not online system users, including individuals who are members of the determined group of individuals and individuals who are not members of the determined group of individuals.

To identify conversion data describing conversions performed by unique individuals, the online system determines an additional group of individuals who performed a conversion based on a set of conversion features and user identifying information included in the conversion data. For example, to determine a number of individuals who performed a conversion, the online system estimates a composition of an additional group of individuals associated with a set of the conversion data such that each individual member of the additional group is a unique individual who performed a conversion. Based on the user identifying information included in the conversion data, the online system identifies an additional group of online system users who performed a conversion. For example, the online system identifies an additional group of online system users associated with user identifying information included in the conversion data.

From the identified additional group of online system users, the online system selects an additional sample subgroup of online system users having at least a threshold measure of similarity to a plurality of individuals who performed a conversion described by the conversion data. For example, the online system identifies an additional sample subgroup of users associated with a frequency distribution of conversion feature values having at least a threshold measure of similarity to a frequency distribution of conversion feature values described by the conversion data. In various embodiments, the online system may use one or more alternative methods of sampling to select the additional subgroup of users from the group of users.

Based on the conversion data associated with the additional subgroup of users, the online system identifies a set of conversion feature values associated with each user of the additional subgroup. The online system uses the identified set of conversion feature values to train a machine learned model (a “conversion model”) used by the online system to determine the additional group of individuals who performed a conversion. In various embodiments, the online system uses one or more machine learning techniques to determine associations between each value of the set of values and to generate weights for each value and/or for different combinations of values. Two or more conversion feature values are associated with each other if the values are associated with the same user of the additional subgroup of users. Weights generated by the online system and included in the conversion model describe strengths of the determined associations between each conversion feature value or combination of values. For example, a numerical weight generated for a particular combination of conversion feature values is proportional to a strength of the determined association between the values.

Based on a strength of the determined association between each conversion feature value or each combination of values, the conversion model predicts a likelihood that conversions associated with certain combinations of the values are associated with a single unique individual. For example, if a weight of 0.8 is generated for a combination of conversion feature values determined to be strongly associated with each other, the conversion model predicts that, for every ten occurrences of the combination of values in the conversion data, eight unique individuals performed a conversion. As another example, if the online system generates a weight of 0.4 for a combination of conversion feature values determined to be moderately associated, the conversion model predicts that, for every ten occurrences of the combination of values in the conversion data, four unique individuals performed a conversion.

The online system applies the conversion model to the values of the conversion features described by the retrieved conversion data to determine the additional group of individuals and conversion feature values associated with the additional group of individuals. For example, the conversion model is configured to receive, as input, information identifying the content item, a publishing user associated with the content item, a type of performed conversion and values of conversion features associated with the conversion. Based on the input, the conversion model predicts likelihoods that certain combinations of the values are associated with unique individuals. Based on the determined likelihoods that certain combinations of the conversion feature values are associated with unique individuals, the online system determines the additional group of individuals who performed a conversion and associates the combinations of the conversion feature values with the additional group of individuals. For example, based on a number of certain conversion feature values included in the conversion data predicted to be associated with unique individuals, the online system determines a number of unique individuals included in the additional group and associates the conversion feature values with the additional group.

In various embodiments, the online system generates one or more metrics describing the additional group of individuals and provides the metric to an entity or user of the online system associated with the content item. For example, the online system generates a metric describing a number of individuals who performed a conversion associated with a content item and provides the metric to a publishing user associated with the content item. In the previous example, the number of individuals who performed a conversion corresponds to the number of individuals in the additional group of individuals, which may differ from the number of conversions described by the conversion data. Hence, application of the conversion model to the retrieved conversion data allows the online system to determine an additional group of identifiable and non-identifiable individuals who performed a conversion and to determine metrics describing conversions performed by the additional group of individuals.

In various embodiments, the online system determines metrics describing an amount of individuals who performed a conversion attributable to presentation of the content item by a content publisher based in part on presentation data associated with the group of individuals and conversion data associated with the additional group of individuals. The online system identifies online system users who were presented with the content item by the specified content publisher and who performed a conversion based on the user identifying information included in the presentation data associated with the group of individuals and the conversion data associated with the additional group of individuals. For example, the online system matches a user identifier included in the presentation data and a user identifier included in the conversion data to determine an online system user associated with the user identifier was presented with the content item and performed a conversion associated with the content item.

Based on presentation features associated with presentation of the content item to the group of individuals and conversion features associated with conversions performed by the additional group of individuals, the online system identifies a sample set of online system users having at least a threshold measure of similarity to a combined population of the group and additional group of individuals. For example, the online system identifies a set of users associated with a frequency distribution of presentation feature values having at least a threshold measure of similarity to a frequency distribution of presentation feature values associated with the group of individuals and conversion feature values having at least a threshold measure of similarity to a frequency distribution of conversion feature values associated with the additional group of individuals. Hence, the online system selects a set of identifiable online system users who were presented with the content item by the content publisher and who performed a conversion associated with the content item as a representative sample of all identifiable and non-identifiable individuals associated with the presentation data and the conversion data.

Based on the presentation data and conversion data associated with the set of users, the online system identifies presentation feature values and conversion feature values associated with each user of the set of users and uses the set of values as training data to train a machine learned model (an “attribution model”) to predict an amount of conversions attributable to presentation of the content item by the content publisher. One or more presentation feature values are associated with one or more conversion feature values if the values are associated with the same user of the set of users. In various embodiments, the online system uses one or more machine learning techniques to train the attribution model to determine associations between different combinations of presentation feature values and conversion feature values and to generate weights describing strengths of the associations. For example, a numerical weight generated for a particular combination of presentation feature values and conversion feature values is proportional to a strength of the determined association between the values.

Based on the strengths of the determined associations, the attribution model predicts a likelihood that certain presentation feature values included in the presentation data are associated with certain conversion feature values included in the conversion data and, therefore, a single unique individual who was presented with the content item and performed a conversion. For example, if a weight of 0.9 is generated for a combination of presentation feature values and conversion feature values determined to be strongly associated, the attribution model predicts that, for every ten occurrences of the combination of values in the presentation data and conversion data, nine unique individuals were presented with the content item by the content publisher and performed a conversion. As another example, if the online system generates a weight of 0.2 for a combination of presentation feature values and conversion feature values determined to be weakly associated, the attribution model predicts that, for every ten occurrences of the combination of values in the presentation data and conversion data, two unique individuals were presented with the content item by the content publisher and performed a conversion.

The online system applies the attribution model to the presentation data received by the online system and conversion data retrieved by the online system to predict an amount of conversions attributable to presentation of the content item by the content publisher. For example, the attribution model is configured to receive, as input, information about the content item, a content publisher that presented the content item, an online system user associated with the content item, a set of presentation feature values associated with presentation of the content item by the content publisher and a set of conversion feature values included in the conversion data. Based on the input, the attribution model predicts likelihoods that certain combinations of the values are associated with unique individuals. Based on the determined likelihoods that certain combinations of the values are associated with unique individuals, the online system determines an amount of individuals presented with the content item by the content publisher who performed a conversion. For example, a number of individuals presented with the content item who performed a conversion corresponds to a number of unique individuals predicted to be associated with certain combinations of strongly associated presentation feature values and conversion feature values included in the presentation data and conversion data.

In various embodiments, the online system generates a metric describing the amount of conversions attributable to presentation of the content item by one or more of the plurality of content publishers who presented the content item based on predictions made by the model. In one embodiment, the online system generates a metric describing a particular content publisher's share of attribution for conversions based on the predicted amount of conversions attributable to presentation of the content item by the content publisher. For example, based on a predicted number of unique individuals who performed a conversion in response to being presented with the content item by each of the plurality of content publishers identified in the presentation data, the online system determines a particular content publisher's percentage share of conversions attributable to presentation of the content item by the content publisher. In the preceding example, the online system applies the attribution model to the presentation data and conversion data to compute a ratio of a predicted number of conversions performed by individuals in response to being presented with the content item by each content publisher to the total number of conversions performed by unique individuals. The metrics may be provided to a publishing user associated with the content item so the publishing user may use the metrics to determine effectiveness of the content item for eliciting certain actions described by the conversion data and/or to compare the effectiveness of the content item for eliciting the actions when presented by each of the plurality of content publishers.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIG. 3 is a flowchart of a method for generating models to measure performance of content presented to a plurality of identifiable and non-identifiable individuals, in accordance with an embodiment.

FIG. 4 is an example of presentation data received by an online system, in accordance with an embodiment.

FIG. 5 is a process diagram illustrating determining a group of individuals presented with a content item by a content publisher, in accordance with an embodiment.

FIG. 6 is an example of conversion data retrieved by an online system, in accordance with an embodiment.

FIG. 7 is a process diagram illustrating determining an additional group of individuals who performed a conversion associated with a content item, in accordance with an embodiment.

FIG. 8 is a process diagram illustrating determining a sample set of identifiable online system users who were presented with a content item and performed a conversion associated with the content item, in accordance with an embodiment.

FIG. 9 is an example data table describing presentation data and conversion data associated with online system users who were presented with a content item and performed a conversion, in accordance with an embodiment.

FIG. 10 is a process diagram illustrating training a machine learned model to predict an amount of conversions attributable to presentation of a content item by a content publisher, in accordance with an embodiment.

FIG. 11 is a process diagram illustrating applying a machine learned model to predict a percentage share of conversions attributable to presentation of a content item by each of a plurality of content publishers, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

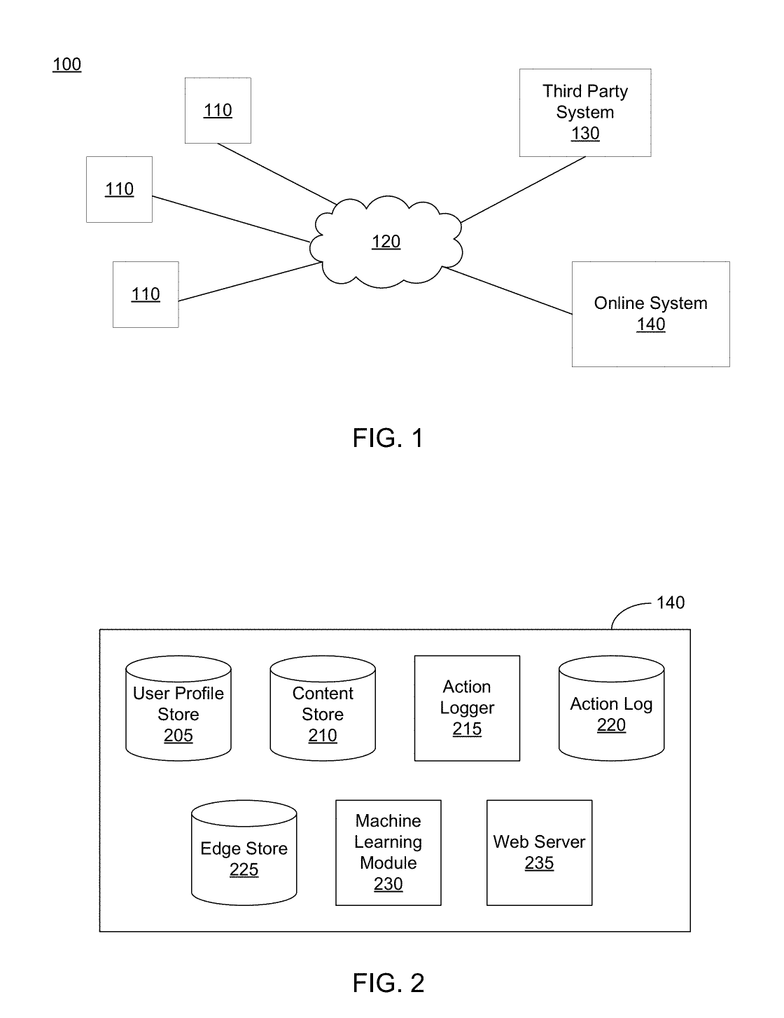

FIG. 1 is a block diagram of a system environment 100 for an online system 140. The system environment 100 shown by FIG. 1 comprises one or more client devices 110, a network 120, one or more third-party systems 130, and the online system 140. In alternative configurations, different and/or additional components may be included in the system environment 100. The online system 140 may be a social networking system, a content sharing network, or another systems providing content to users.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone, a smartwatch, or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device 110. In other embodiments, a third party system 130 provides content or other information for presentation via a client device 110. A third party system 130 may also communicate information to the online system 140, such as advertisements, content, or information about an application provided by the third party system 130.

In some embodiments, one or more of the third party systems 130 provide content to the online system 140 for presentation to users of the online system 140 and provide compensation to the online system 140 in exchange for presenting the content. For example, a third party system 130 provides content items to the online system 140 for presentation to online system users and amounts of compensation provided by the third party system 130 to the online system 140 in exchange presenting content items to the online system users. Content for which the online system 140 receives compensation in exchange for presenting is referred to herein as “sponsored content.” Sponsored content from a third party system 130 may be associated with the third party system 130 or with another entity on whose behalf the third party system 130 operates.

FIG. 2 is a block diagram of an architecture of the online system 140. The online system 140 shown in FIG. 2 includes a user profile store 205, a content store 210, an action logger 215, an action log 220, an edge store 225, a machine learning module 230, and a web server 240. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the online system users displayed in an image, with information identifying the images in which a user is tagged stored in the user profile of the user. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other online system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity. In some embodiments, the brand page associated with the entity's user profile may retrieve information from one or more user profiles associated with users who have interacted with the brand page or with other content associated with the entity, allowing the brand page to include information personalized to a user when presented to the user.

The content store 210 stores objects that each represent various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system 140, events, groups or applications. In some embodiments, objects are received from third-party applications, such as third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

One or more content items included in the content store 210 include content for presentation to a user and a bid amount. The content is text, image, audio, video, or any other suitable data presented to a user. In various embodiments, the content also specifies a page of content. For example, a content item includes a landing page specifying a network address of a page of content to which a user is directed when the content item is accessed. The bid amount is included in a content item by a user and is used to determine an expected value, such as monetary compensation, provided by an advertiser to the online system 140 if content in the content item is presented to a user, if the content in the content item receives a user interaction when presented, or if any suitable condition is satisfied when content in the content item is presented to a user. For example, the bid amount included in a content item specifies a monetary amount that the online system 140 receives from a user who provided the content item to the online system 140 if content in the content item is displayed. In some embodiments, the expected value to the online system 140 of presenting the content from the content item may be determined by multiplying the bid amount by a probability of the content of the content item being accessed by a user.

Various content items may include an objective identifying an interaction that a user associated with a content item desires other users to perform when presented with content included in the content item. Example objectives include: installing an application associated with a content item, indicating a preference for a content item, sharing a content item with other users, interacting with an object associated with a content item, or performing any other suitable interaction. As content from a content item is presented to online system users, the online system 140 logs interactions between users presented with the content item or with objects associated with the content item. Additionally, the online system 140 receives compensation from a user associated with content item as online system users perform interactions with a content item that satisfy the objective included in the content item.

Additionally, a content item may include one or more targeting criteria specified by the user who provided the content item to the online system 140. Targeting criteria included in a content item request specify one or more characteristics of users eligible to be presented with the content item. For example, targeting criteria are used to identify users having user profile information, edges, or actions satisfying at least one of the targeting criteria. Hence, targeting criteria allow a user to identify users having specific characteristics, simplifying subsequent distribution of content to different users.

In one embodiment, targeting criteria may specify actions or types of connections between a user and another user or object of the online system 140. Targeting criteria may also specify interactions between a user and objects performed external to the online system 140, such as on a third party system 130. For example, targeting criteria identifies users that have taken a particular action, such as sent a message to another user, used an application, joined a group, left a group, joined an event, generated an event description, purchased or reviewed a product or service using an online marketplace, requested information from a third party system 130, installed an application, or performed any other suitable action. Including actions in targeting criteria allows users to further refine users eligible to be presented with content items. As another example, targeting criteria identifies users having a connection to another user or object or having a particular type of connection to another user or object.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with the particular users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, checking-in to physical locations via a client device 110, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), engaging in a transaction, viewing an object (e.g., a content item), and sharing an object (e.g., a content item) with another user. Additionally, the action log 220 may record a user's interactions with content items on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce websites, such as in the preceding example, may communicate information about a user's actions outside of the online system 140 to the online system 140 for association with the user. Hence, the action log 220 may record information about actions users perform on a third party system 130, including webpage viewing histories, content that was engaged, purchases made, and other patterns from shopping and buying. Additionally, actions a user performs via an application associated with a third party system 130 and executing on a client device 110 may be communicated to the action logger 215 by the application for recordation and association with the user in the action log 220.

The action log 220 may also include information describing presentation of content to online system users by various entities and actions associated with the content performed by the users. Information describing presentation of content to online system users by various entities stored in the action log 220 includes presentation data which comprises information identifying a content item presented to a user, an additional user or entity associated with the content item, an entity that presented the content item to the user, user identifying information associated with the user, a time associated with the presentation, and one or more additional attributes associated with the presentation. Multiple types of user identifying information may be associated with presentation of a content item to a user and stored in the action log 220, allowing the online system 140 to identify a user presented with the content item. Example types of user identifying information include an online system user identifier, a device identifier, an application identifier, and a browser identifier from which the online system 140 may identify a user presented with a content item. For example, the online system 140 identifies an individual associated with user identifying information by comparing the user identifying information with information maintained by the online system 140 describing an identity of the individual.

Additional attributes associated with presentation of content described by information included in the action log 220 may include one or more presentation features identifying a web browser on which a content item was presented to the user, a privacy setting associated with the web browser, a client device 110 on which the content item was presented to the user, and an operating system operating on the client device 110. The various entities that may present content items to users include various content publishers associated with a website and/or application for presenting electronic content to target audiences via client devices 110 associated with members of the audiences. For example, the entities include the online system 140 and one or more third party systems 130 that present sponsored and organic content items to target audiences that include one or more users of the online system 140 via certain websites.

Presentation data stored in the action log 220 describing presentation of content by an entity other than the online system 140 may be received by the action logger 215 from the entity that presented the content or a third party system 130. For example, the action logger 215 receives presentation data describing presentation of content to online system users from a data analytics provider that tracks presentations of content to various individuals by various content publishers and identifies attributes associated with the individuals and with the presentation of the content to the individuals. Hence, the action log 220 includes information describing presentation of content to online system users by entities other than, or in addition to, the online system 140.

The action log 220 may also include information describing actions performed by users of the online system 140 which are associated with content presented to the users. Example actions described by the information include visits by a user to a website or physical location associated with a content item and purchases by the user of a product or service associated with the content item. The information describing the actions performed by the users may include conversion data, which is information describing a type of action performed by a user, a content item associated with the action, user identifying information associated with the user, a time associated with the action, an entity or additional user associated with the content item, and one or more additional attributes associated with performance of the action. Additional attributes associated with performance of an action by a user include one or more conversion features identifying a web browser on which the action was performed, a privacy setting associated with the web browser, a client device 110 on which the action was performed, and an operating system executing on the client device 110.

Conversion data describing actions performed by a user may be determined by the online system 140 or received by the action logger 215 from a third party system 130 or an online system user associated with the action. For example, an online system user associated with a content item provides periodic information to the online system 140 which includes conversion data describing purchases made on a website associated with the user; the action logger 215 stores the information in the action log 220. In this example, the information describes a time and user identifying information associated with each purchase, a content item associated with each purchase, and a client device identifier associated with each purchase.

The action log 220 may also include information describing presentation of content to individuals other than, or in addition to, online system users by various entities, and actions performed by the individuals. For example, while the online system 140 stores presentation data describing presentations of content to an online system user in association with an online system user identifier, presentation data describing presentations of content to an individual other than an online system user is stored in association with a client device identifier associated with a client device on which the content item was presented. As another example, the online system 140 stores conversion data describing actions performed by online system users in association with online system user identifiers and actions performed by individuals other than online system users in association with a browser identifier. In this example, the browser identifier includes information such as a version, installed plugins, system fonts and cookie settings that may be used by the online system 140 to uniquely identify a browser on which the actions were performed. Hence, the action log 220 includes information describing presentation of content to individuals other than, or in addition to, online system users as well as actions performed by the individuals.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

An edge may include various features that each represent characteristics of interactions between users, interactions between users and objects, or interactions between objects. For example, features included in an edge describe a rate of interaction between two users, how recently two users have interacted with each other, a rate or an amount of information retrieved by one user about an object, or numbers and types of comments posted by a user about an object. The features may also represent information describing a particular object or a particular user. For example, a feature may represent the level of interest that a user has in a particular topic, the rate at which the user logs into the online system 140, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate the user's interest in an object, in a topic, or in another user in the online system 140 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

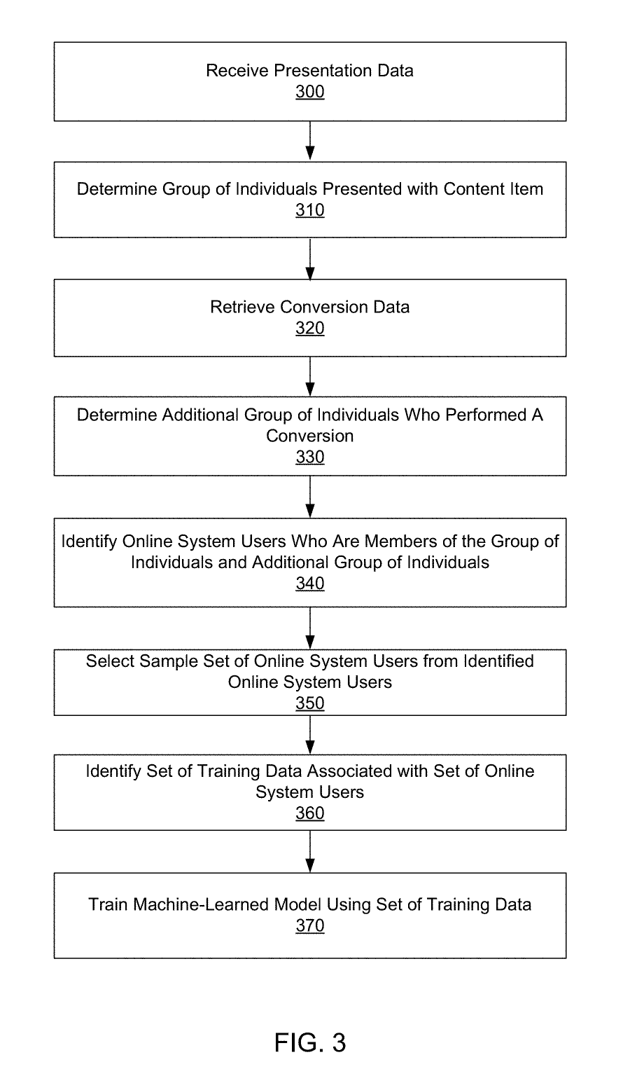

The machine learning module 230 trains one or more machine learned models to predict information associated with content presented to a plurality of individuals by various content publishers. As further described below in conjunction with FIGS. 3-11, information predicted by the machine learned models describes a number of individuals presented with a content item by a content publisher, a group of individuals presented with the content item by the content publisher, a number of individuals who performed an action associated with the content item, an additional group of individuals who performed the action associated with the content item, and/or a number of individuals who performed the action associated with the content item in response to being presented with the content item, in various embodiments. Information predicted by the machine learning module 230 may be used by the online system 140 to measure performance of the content and to determine metrics describing performance of the content and of the content presentation by one or more content publishers, in various embodiments.

In certain embodiments, the machine learning module 230 trains a machine learned model (“presentation model”) to predict an amount of individuals presented with a content item by a content publisher based on presentation data received by the online system 140. Presentation data received by the online system 140 describes presentation of a content item to a plurality of individuals by one or more content publishers and includes one or more presentation features associated with each presentation of the content item, values of the presentation features, and user identifying information associated with some of the individuals presented with the content item. The plurality of individuals presented with the content item includes individuals who are users of the online system 140 and/or individuals other than users of the online system 140. Example types of user identifying information associated with the one or more individuals include an online system user identifier, a device identifier, an application identifier, a browser identifier, and any other suitable information from which the online system 140 may identify or distinguish an individual presented with the content item.

In some embodiments, the presentation data is received from a content publisher that presented the content item to the individuals, while in other embodiments the presentation data is received from a third party system 130 that tracks presentation of content by different content publishers and compiles information describing presentation of the content. For example, the online system 140 receives a table of presentation data from a content publisher describing values of presentation features associated with each presentation of a content item by the content publisher and different types of user identifying information associated with one or more individuals presented with the content item. Presentation features included in the presentation data describe one or more dimensions associated with presentation of the content item to an individual by a content publisher. Example dimensions on which presentation features may be based describe a web browser on which a content item was presented to an individual by a content publisher, a privacy setting associated with the web browser, a client device 110 on which the content item was presented to the individual by the content publisher, and an operating system operating on the client device 110.

Presentation features based on each dimension may have various values along the dimension such that a value of the presentation feature describes an attribute associated with presentation of the content item to an individual. For example, a presentation feature based on a web browser on which a content item was presented to an individual comprises a value of Safari, Android Browser, Chrome, Internet Explorer, or Firefox. In this example, the value of the presentation feature identifies a type of web browser on which the individual was presented with the content item. As another example, a presentation feature based on a client device 110 on which the content item was presented to an individual comprises a value of mobile phone, laptop computer, desktop computer, or tablet. In this example, the value of the presentation feature identifies a type of client device on which the content item was presented to the individual.

To train the presentation model, the machine learning module 230 identifies presentation data describing presentation of the content item to a group of online system users (e.g., during a specified time interval) and identifies presentation features described by the presentation data. For example, the machine learning module 230 identifies presentation data describing presentation of the content item to a group of individuals associated with user identifying information comprising online system user identifiers. The machine learning module 230 identifies values of the presentation features included in the presentation data and determines a subgroup of the group of online system users based on the values. In one embodiment, the machine learning module 230 identifies a subgroup of users having at least a threshold measure of similarity to the plurality of individuals presented with the content item based on the identified values. For example, the subgroup of users is associated with a frequency distribution of presentation feature values having at least a threshold measure of similarity to a frequency distribution of presentation feature values associated with the plurality of individuals from which the sample subgroup is identified. In various embodiments, the machine learning module 230 may use one or more alternative methods of sampling to select the sample subgroup of users from the group of users. For example, the machine learning module 230 uses one or more of a random sampling technique, a systematic sampling technique, a stratified sampling technique, and a cluster sampling technique to select the sample subgroup of users.

The machine learning module 230 uses the values of the presentation features associated with the subgroup of users as training data to train the presentation model. For example, the machine learning module 230 generates weights for each presentation feature value and for different combinations of the presentation feature values. In the preceding example, a weight generated for a particular combination of presentation feature values may describe an association between the combined presentation feature values based on a frequency distribution of the combination among the sample subgroup of users. In various embodiments, one or more machine learning techniques may be implemented to train the presentation model to determine associations between values of presentation features included in the presentation data and to generate weights describing the associations. For example, the machine learning techniques may include a classification technique, a clustering technique, a decision tree learning technique, a random forest technique, a logistic regression technique, a linear regression technique, and a gradient boosting technique.

The online system 140 applies the presentation model to values of presentation features associated with the plurality of individuals presented with the content item to predict a number of unique individuals presented with the content item (e.g., by a particular content publisher). For example, the presentation model is configured to receive, as input, information about a content item, a content publisher that presented the content item, and values of presentation features included in the presentation data to predict a number of unique individuals associated with the presentation feature values described by the presentation data. The online system 140 may use the predicted number of unique individuals associated with the presentation feature values to generate a metric describing a number of individuals presented with the content item by a specified content publisher. Additionally, or alternatively, the online system 140 applies the presentation model to values of presentation features associated with the plurality of individuals to determine a group of unique individuals presented with the content item by a specified content publisher, as described below in conjunction with FIGS. 3-5.

In other embodiments, the machine learning module 230 trains a machine learned model (“conversion model”) to predict a number of individuals who performed a conversion associated with a content item based on conversion data retrieved by the online system 140. Conversion data retrieved by the online system 140 describes performance of conversions by a plurality of individuals and includes one or more conversion features associated with each conversion performed by an individual. The conversion data also includes values of the conversion features and user identifying information associated with some of the individuals who performed a conversion. A conversion is the occurrence of one or more particular actions associated with a content item performed by an individual. Example conversions include visits by an individual to a website or physical location associated with a content item or an entity associated with the content item and purchases by the individual of a product or service associated with the content item or an entity associated with the content item. Individuals who may perform the one or more actions comprising a conversion include online system users and/or individuals other than online system users.

Information comprising the conversion data may be retrieved from the action log 220, the user profile store 205, or the edge store 225, in some embodiments. For example, the action logger 215 receives conversion data from an entity associated with the conversions as the conversions occur or at periodic time intervals and stores the conversion data in the action log 220 for later retrieval. As another example, the conversion data is retrieved from stored information received from a third party system 130 that tracks conversions and compiles information describing the conversions. User identifying information included in the conversion data includes an online system user identifier, a device identifier, an application identifier, a browser identifier, and any other suitable information from which the online system may identify or distinguish an individual who performed a conversion described by the conversion data.

Conversion features included in the conversion data describe one or more dimensions associated with performance of a conversion by an individual. Example dimensions on which conversion features may be based include a web browser on which the conversion occurred, a privacy setting associated with the web browser, a client device 110 on which the conversion occurred, and an operating system executing on the client device 110. Conversion features based on each dimension may have various values along the dimension such that a value of the conversion feature describes an attribute associated with performance of a conversion. For example, a conversion feature based on a privacy setting associated with a web browser on which a conversion occurred comprises a value of a cookie setting on the browser, such as a setting that blocks all cookies, blocks cookies not meeting certain criteria, restricts all cookies, restricts cookies not meeting certain criteria, or saves all cookies. In this example, the value of the conversion feature identifies a privacy setting associated with a web browser on which an individual performed a conversion. As another example, a conversion feature based on an operating system executing on a client device 110 on which a conversion occurred comprises a value of Microsoft Windows, Mac OS, Linux, or Android. In this example, the value of the conversion feature identifies a type of operating system executing on a client device on which the individual performed a conversion.

To train the conversion model, the machine learning module 230 identifies conversion data describing performance of conversions by a group of online system users (e.g., during a specified time interval) and identifies conversion features described by the conversion data. For example, the machine learning module 230 identifies conversion data describing performance of conversions by a group of individuals associated with user identifying information comprising online system user identifiers. The machine learning module 230 determines the values of the conversion features described by the conversion data and identifies a subgroup of online system users from the group of online system users based on the determined values, in various embodiments.

In some embodiments, the machine learning module 230 identifies a subgroup of users having at least a threshold measure of similarity to a plurality of individuals who performed a conversion described by the conversion data. For example, the machine learning module 130 identifies a subgroup of users associated with a frequency distribution of conversion feature values having at least a threshold measure of similarity to a frequency distribution of conversion feature values described by the conversion data. In various embodiments, the machine learning module 230 may use one or more alternative methods of sampling to select the subgroup of users from the group of users. For example, the machine learning module 130 may use one or more sampling methods including a random sampling technique, a systematic sampling technique, a stratified sampling technique, and a cluster sampling technique.

The machine learning module 230 uses the values of the conversion features associated with the subgroup of users as training data to train the conversion model. For example, the machine learning module 230 generates weights for each conversion feature value and for different combinations of conversion feature values. In this example, a weight generated for a particular combination of conversion feature values describes an association between the combined conversion feature values based on a frequency distribution of the combination among the sample subgroup of users. In various embodiments, one or more machine learning techniques may be implemented to train the conversion model to determine associations between values of conversion features included in the conversion data and to generate weights describing the associations. For example, the machine learning techniques may include a classification technique, a clustering technique, a decision tree learning technique, a random forest technique, a logistic regression technique, a linear regression technique, and a gradient boosting technique.

The online system 140 applies the conversion model to values of conversion features described by the conversion data to predict a number of unique individuals who performed a conversion. For example, the conversion model is configured to receive, as input, information about a content item, an entity associated with the content item, a type of action performed by an individual, and values of conversion features described by the conversion data to predict a number of unique individuals associated with the conversion data. The online system 140 may use the predicted number of unique individuals associated with the conversion data to generate a metric describing a number of individuals who performed a conversion described by the conversion data. Additionally, or alternatively, the online system 140 applies the conversion model to values of conversion features described by the conversion data to determine a group of unique individuals who performed a conversion associated with the content item, as described below in conjunction with FIGS. 3, 6 and 7.

In yet other embodiments, the machine learning module 230 trains a machine learned model (“attribution model”) to predict an amount of conversions described by the conversion data attributable to presentation of a content item by each of a plurality of content publishers. To train the attribution model, the machine learning module 230 retrieves presentation data describing presentation of the content item to a plurality of individuals including a group of online system users by the plurality of content publishers and determines a group of unique individuals presented with the content item by the content publishers. For example, the machine learning module 230 applies a trained presentation model to the retrieved presentation data, as described herein, and determines a group of unique individuals presented with the content item by the content publishers using the presentation model. The machine learning module 230 also retrieves conversion data describing conversions associated with the content item and determines an additional group of unique individuals who performed a conversion. For example, the machine learning module 230 applies a trained conversion model, as described herein, to the conversion data and determines the additional group of individuals who performed a conversion using the conversion model.

Based on the user identifying information included in the presentation data and conversion data, the machine learning module 230 identifies a plurality of online system users who are members of the determined group of individuals and additional group of individuals. For example, the machine learning module 230 matches online system user identifiers included in the presentation data with corresponding online system user identifiers included in the conversion data and identifies a plurality of online system users associated with the matched online system user identifiers. The machine learning module 230 also identifies values of presentation features associated with the group of individuals and values of conversion features associated with the additional group of individuals, which includes values of presentation features and conversion features associated with the identified plurality of online system users.

Based on the identified values, the machine learning module 230 identifies a set of online system users from the plurality of online system users having at least a threshold measure of similarity to the group of individuals and additional group of individuals. For example, the set of users is associated with a frequency distribution of presentation feature values having at least a threshold measure of similarity to a frequency distribution of presentation feature values associated with the group of individuals; the set of users is also associated with a frequency distribution of conversion feature values having at least a threshold measure of similarity to a frequency distribution of conversion feature values associated with the additional group of individuals. In various embodiments, the machine learning module 230 may use one or more alternative methods of sampling to identify the set of users. For example, the machine learning module 230 may use a random sampling technique, a systematic sampling technique, a stratified sampling technique, and/or a cluster sampling technique.

The machine learning module 230 uses the values of the presentation features and conversion features associated with the set of users as training data to train the attribution model. For example, the machine learning module 230 generates weights for different combinations of conversion feature values and presentation feature values associated with the set of online system users describing a strength of an association between the combined values. One or more machine learning techniques may be used by the machine learning module 230 to train the attribution model to determine associations between the presentation feature values and conversion feature values, and/or between different combinations of presentation feature values and conversion feature values, and to generate weights describing the associations. For example, the machine learning techniques may include a classification technique, a clustering technique, a decision tree learning technique, a random forest technique, a logistic regression technique, a linear regression technique, and a gradient boosting technique.

The online system 140 applies the attribution model to values of presentation features and conversion features described by the presentation data and conversion data to predict an amount of conversions attributable to presentation of the content item by each of the content publishers. In one embodiment, the attribution model is configured to receive, as input, information about the content item, a content publisher that presented the content item, an entity associated with the content item, a type of conversion, and values of presentation features and conversion features included in the presentation data and conversion data. For example, weights generated by the machine learning module 230 for each combination of conversion feature values and presentation feature values are applied to a frequency of each combination in the presentation data and conversion data to predict an amount of individuals associated with the combined presentation feature values and conversion feature values. In the preceding example, the predicted amount of individuals associated with the combined presentation feature values and conversion feature values corresponds to a predicted amount of individuals who were presented with the content item and performed a conversion, i.e., a predicted amount of conversions attributable to presentation of the content item by the content publishers.

Based on a predicted amount of individuals who performed conversions attributable to presentation of the content item and who are associated with presentation features describing presentation of the content item by a specified content publisher, the online system 140 predicts an amount of conversions attributable to presentation of the content item by the content publisher, in some embodiments. For example, the online system 140 determines a percentage of conversions attributable to presentation of the content item by a specified content publisher corresponding to a predicted percentage of conversions performed by individuals associated with presentation feature values describing presentation of the content item by the content publisher. Training and application of an attribution model to predict an amount of conversions attributable to presentation of a content item by content publishers is further described in conjunction with FIGS. 3-11.

The web server 240 links the online system 140 via the network 120 to the one or more client devices 110, as well as to the one or more third party systems 130. The web server 240 serves web pages, as well as other content, such as JAVA®, FLASH®, XML and so forth. The web server 240 may receive and route messages between the online system 140 and the client device 110, for example, instant messages, queued messages (e.g., email), text messages, short message service (SMS) messages, or messages sent using any other suitable messaging technique. A user may send a request to the web server 240 to upload information (e.g., images or videos) that are stored in the content store 210. Additionally, the web server 240 may provide application programming interface (API) functionality to send data directly to native client device operating systems, such as IOS®, ANDROID™, or BlackberryOS.

### Generating Models to Measure Performance of Content Presented to a Plurality of Identifiable and Non-Identifiable Individuals

FIG. 3 is a flowchart of one embodiment of a method for generating models to measure performance of content presented to a plurality of identifiable and non-identifiable individuals. In other embodiments, the method may include different and/or additional steps than those shown in FIG. 3. Additionally, steps of the method may be performed in different orders than the order described in conjunction with FIG. 3 in various embodiments.

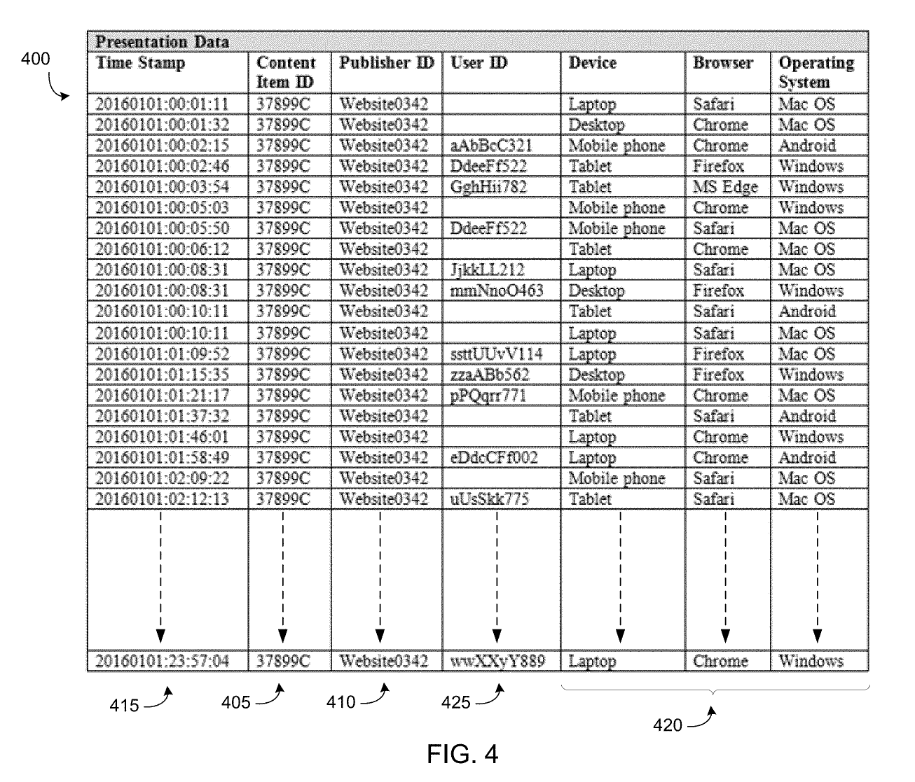

The online system 140 receives 300 presentation data describing presentation of a content item to a plurality of individuals by a plurality of content publishers. For example, as shown in FIG. 4, the online system 140 receives 300 a table 400 of presentation data including information identifying the content item presented to the individuals (e.g., a content item identifier 405), the content publishers that presented the content item (e.g., a content publisher identifier 410), and a time associated with each presentation of the content item (e.g., a time stamp 415). The table 400 of presentation data also includes presentation features 420 associated with each presentation of the content item and user identifying information (e.g., an online system user identifier 425) associated with some of the individuals presented with the content item. The content item may be a sponsored content item (e.g., an advertisement) for which a content publisher receives compensation in exchange for presenting to an individual, or an organic content item (e.g., a user-generated story) for which the content publisher receives no compensation in exchange for presenting to an individual. Content publishers identified by the presentation data include various entities associated with websites and/or applications for presenting electronic content to targeted audiences of individuals via client devices 110 associated with the individuals. For example, the content publishers include the online system 140 and one or more third party systems 130 that present sponsored and organic content to targeted audiences of individuals including online system users.

In some embodiments, the presentation data is received 300 from one or more content publishers that presented the content item, while in other embodiments the presentation data is received 300 from a third party system 130, such as a data analytics provider that tracks presentations of content by various content publishers and compiles data describing the presentations. In yet other embodiments, presentation data is received 300 from a client device 110 presenting the content item to an individual or an application executing on the client device 110 presenting the content item to the individual. For example, a client device 110 presenting the content item to an individual communicates presentation data describing the presentation in response to instructions included in the content item that cause the client device 110 to communicate data to the online system 140.

Presentation features 420 included in the presentation data identify values of attributes associated with each presentation of the content item by a content publisher. In various embodiments, the presentation features 420 identify values of attributes describing a web browser on which the content item was presented, a privacy setting associated with the web browser, a client device 110 on which the content item was presented, and/or an operating system operating on the client device 110. For example, if the content item was presented to an individual via a Safari web browser associated with a high privacy cookie setting and the web browser was executing on an iPad tablet operating on an iOS 10 operating system, the presentation data includes presentation features 420 identifying values of Safari, high privacy, iPad, tablet, and/or iOS 10.

In the example of FIG. 4, presentation features 420 included in the presentation data identify values describing client devices 110 on which the content items were presented, browsers on which the content items were presented, and operating systems executing on the client devices 110 on which the content items were presented. For example, a presentation feature 420 describing a client device 110 on which the content item was presented identifies a value of laptop computer, desktop computer, mobile phone, or tablet. Although the values of the presentation feature 420 in the previous example identify a type of client device 110, in other embodiments, the value may alternatively or additionally identify a brand of the client device 110 (e.g., Apple, Sony, Samsung, etc.) or a model of the client device 110 (e.g., iPhone, Vaio, Galaxy, etc.). As another example, a presentation feature 420 describing a browser on which the content item was presented identifies a value of Safari, Chrome, Firefox, or MS Edge. In this example, a presentation feature 420 describing an operating system executing on a client device 110 on which the content item was presented identifies a value of Mac OS, Android, or Windows.

Presentation data received 300 by the online system 140 also includes user identifying information associated with some of the individuals presented with the content item. User identifying information is information used by the online system 140 to identify an individual associated with the user identifying information or to distinguish the individual from individuals not associated with the user identifying information, such as individuals associated with different or no user identifying information. For example, the online system 140 identifies an individual associated with user identifying information by comparing the user identifying information with information maintained by the online system 140 describing an identity of the individual. Example types of user identifying information include an online system user identifier 425, a client device identifier, an application identifier, a browser identifier, and any other suitable information from which the online system 140 may identify or distinguish an individual presented with the content item.

In various embodiments, the online system 140 identifies individuals presented with the content item to determine a “reach” of the content item (i.e., a number of individuals presented with the content item). For example, if every presentation of the content item is associated with an online system user identifier 425, the online system 140 determines a number of individuals presented with the content item by computing a number of unique online system user identifiers 425 included in the presentation data. In this example, the number of unique online system user identifiers 425 included in the presentation data corresponds to the number of individuals presented with the content item, which may be a different number than the number of presentations of the content item described by the presentation data (e.g., due to multiple presentations of the content item to a single individual).

However, as illustrated in the example of FIG. 4, while presentation data received 300 by the online system 140 includes user identifying information associated with some individuals presented with the content item, user identifying information is not associated with every presentation of the content item. For example, the presentation data may include online system user identifiers 425 associated with individuals who were logged into the online system 140 when presented with the content item but not include online system user identifiers 425 associated with individuals who were not logged into the online system 140 when presented with the content item. If the presentation data describes one or more presentations of the content item not associated with user identifying information, the online system 140 may be unable to distinguish between multiple presentations of the content item to a single individual and multiple presentations of the content item to multiple individuals. For example, while the presentation data illustrated in FIG. 4 describes at least two presentations of the content item to an individual associated with the online system user identifier 425 “DdeeFf522” and single presentations of the content item to each other individual associated with an online system user identifier 425, it is unclear from the received presentation data whether multiple presentations of the content item not associated with user identifying information correspond to presentations of the content item to a single individual or to multiple individuals. Hence, the number of presentations described by the presentation data may be different than the number of individuals presented with the content item.

To identify presentation data describing presentation of the content item to a unique group of individuals, the online system 140 determines 310 a group of individuals presented with the content item by a specified content publisher based on a set of presentation features 420 and user identifying information included in the presentation data. For example, the online system 140 estimates a composition of a group of individuals associated with a set of the presentation data such that each individual member of the group is a unique individual presented with the content item by the specified content publisher. The content publisher may be specified by the online system 140 or by an online system user associated with the content item, such as a publishing user of the online system 140 who is associated with the content item and has requested a metric describing presentation of the content item by the content publisher.

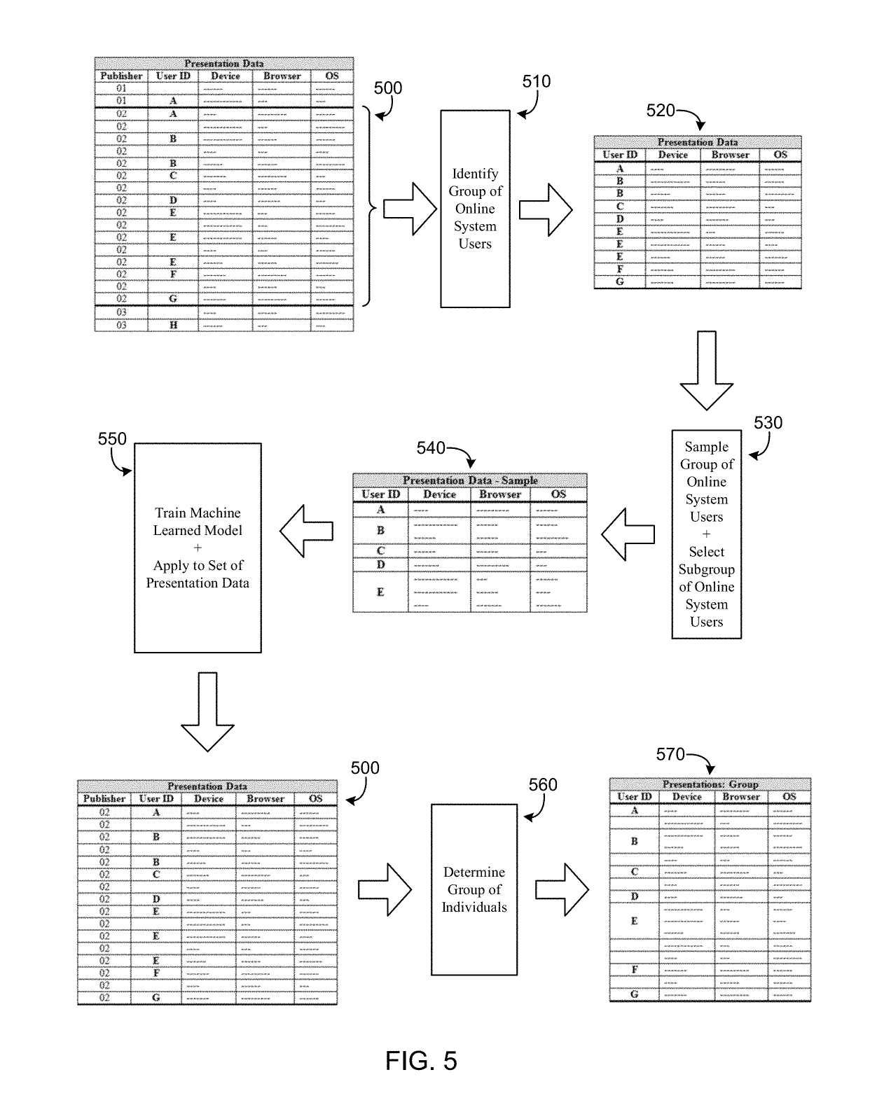

To determine 310 the group of individuals, the online system 140 identifies a group of online system users who were presented with the content item by the specified content publisher and who are associated with user identifying information included in the presentation data. For example, referring to FIG. 5, the online system 140 identifies a set 500 of presentation data describing presentation of the content item to a plurality of individuals by a specified content publisher and identifies 510 a group of online system users associated with user identifying information included in the set 500 of presentation data. In this example, the identified group of online system users includes eight online system users who were presented with the content item by the specified content publisher and who are associated with online system user identifiers 425 (“A” through “G”) and a subset 520 of the presentation data included in the set 500 of presentation data.

The online system 140 samples 530 the identified group of online system users to select 530 a subgroup of online system users having at least a threshold measure of similarity to the plurality of individuals described by the presentation data. In some embodiments, the online system 140 selects 530 a subgroup of online system users associated with a frequency distribution of presentation feature values having at least a threshold measure of similarity to a frequency distribution of presentation feature values associated with the plurality of individuals from which the group of online system users is identified. For example, if presentation features 420 describing presentation of the content item by the content publisher indicate a percentage of the presentations occurring on a mobile phone, a tablet and a laptop are 70%, 20% and 10%, the online system 140 selects 530 a subgroup of users for which approximately 70%, 20% and 10% of presentations of the content item to users of the subgroup occurred on a mobile phone, a tablet and a laptop. In various embodiments, the online system 140 may use one or more alternative methods of sampling to select 530 the subgroup of users from the identified group of users. For example, the online system 140 may use one or more sampling methods including a random sampling technique, a systematic sampling technique, a stratified sampling technique, and a cluster sampling technique.

The online system 140 identifies a set 540 of presentation feature values associated with each user of the subgroup of users and uses the set 540 of presentation feature values to train 550 a machine learned model (a “presentation model”) used by the online system 140 to determine 310 the group of individuals presented with the content item by the content publisher. In various embodiments, the machine learning module 230 of the online system 140 uses one or more machine learning techniques to determine associations between each value of the set 540 of presentation feature values associated with the subgroup of users and to generate weights for each value and/or different combinations of values. For example, the machine learning techniques may include a classification technique, a clustering technique, a decision tree learning technique, a random forest technique, a logistic regression technique, a linear regression technique, and a gradient boosting technique.

Two or more presentation feature values are associated with each other if the values are associated with the same user of the subgroup of users. Weights generated by the machine learning module 230 and included in the presentation model describe a strength of the determined associations between each presentation feature value or combination of values. For example, a weight generated for a particular combination of values is proportional to a likelihood that the values are related based on an identified frequency of the combination of values included in the set 540 of presentation feature values associated with the subgroup of users.

Based on a strength of the determined associations between each value or each combination of values, the presentation model predicts a likelihood that presentations of the content item associated with certain combinations of values are associated with a single unique individual. For example, if a weight of 0.9 is generated for a combination of presentation feature values determined to be strongly associated with each other, the presentation model predicts that, for every ten occurrences of the combination of values in the presentation data received 300 by the online system 140, nine unique individuals were presented with the content item by the specified content publisher. As another example, if the machine learning module 230 generates a weight of 0.3 for a combination of presentation feature values determined to be weakly associated, the presentation model predicts that 3% of the occurrences of the combination of values in the presentation data received 300 by the online system 140 are associated with a unique individual who was presented with the content item by the specified content publisher.

In the example of FIG. 5, the machine learning module 230 generates weights for each presentation feature value (e.g., device, browser and operating system) and for different combinations of presentation feature values (e.g., device and browser, device and operating system, and browser and operating system) based on the frequency distribution of each combination of values associated with the subgroup of users. Weights describing a strong association between certain combinations of the values indicate a high likelihood that multiple presentations of the content item associated with the combinations correspond to multiple presentations of the content item to a single unique individual. For example, the machine learning module 230 generates a weight of 0.8 or higher for a particular combination of presentation feature values if there is an 80% probability that the combination is associated with a single unique individual. In the preceding example, the weight of 0.8 may be based on a determination that at least eight out of every ten users of the subgroup of users associated with two or more presentation feature values of a combination of five presentation feature values are also associated with two or more other presentation feature values of the combination of five presentation feature values.

The online system 140 applies 550 the trained presentation model to values of the presentation features 420 described by the set 500 of presentation data describing presentation of the content item to the plurality of individuals by the content publisher. In one embodiment, the presentation model is configured to receive, as input, a content item identifier identifying the content item, a content publisher that presented the content item and values of presentation features 420 associated with the presentations. Based on the input, the presentation model predicts likelihoods that certain combinations of the values are associated with unique individuals and extrapolates a number of unique individuals associated with each combination. For example, weights generated for different combinations of presentation feature values are applied to a number of occurrences of each combination of the values in the set 500 of presentation data to extrapolate a number of unique individuals associated with each combination of values and, conversely, a plurality of presentation feature values associated with each unique individual. Based on the extrapolated a number of unique individuals associated with each combination of the presentation feature values and presentation feature values associated with each unique individual, the online system 140 determines 310, 560 the group of individuals presented with the content item by the content publisher and a plurality of presentation feature values associated with the group of individuals 570.

In various embodiments, the online system 140 generates one or more metrics describing the group of individuals and provides the metric to an entity or user of the online system 140 associated with the content item. For example, the online system 140 generates a metric describing a number of individuals presented with the content item by the specified content publisher and provides the metric to a publishing user associated with the content item. In the previous example, the number of individuals presented with the content item by the content publisher corresponds to a number of individuals in the determined group of individuals, which may differ from the number of presentations of the content item described by the presentation data. Hence, application of the presentation model to the received presentation data allows the online system 140 to determine 310, 560 a group of identifiable and non-identifiable individuals presented with the content item by the content publisher and to determine metrics describing presentation of the content item to the individuals.

To determine information describing occurrences of certain events associated with presentation of the content item to the plurality of individuals, the online system 140 retrieves 320 conversion data describing occurrences of a conversion associated with the content item. As described above in conjunction with FIG. 2, occurrences of a conversion associated with the content item include the performance of one or more particular actions associated with the content item by an individual. Example conversions include visits by an individual to a website or physical location associated with the content item or an entity associated with the content item and purchases by the individual of a product or service associated with the content item or an entity associated with the content item.

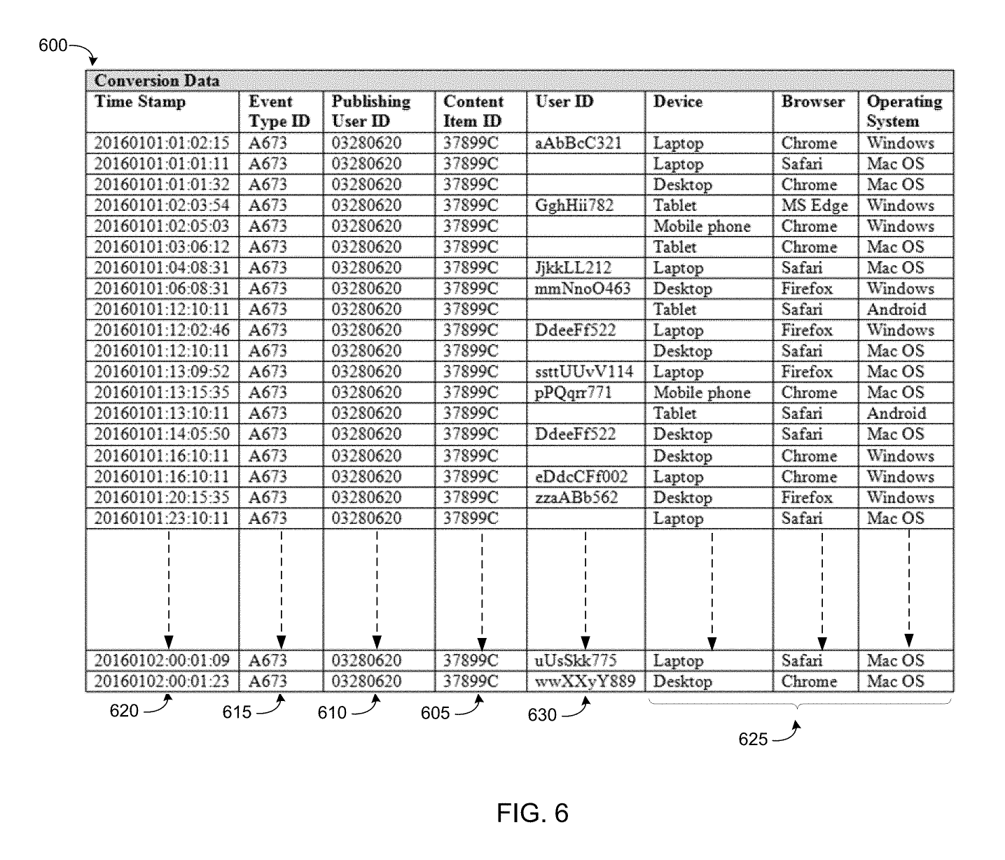

Conversion data retrieved 320 by the online system 140 includes information identifying the content item associated with the conversion, an online system user or entity associated with the content item, a type of conversion associated with the content item, and a time of occurrence of each conversion. For example, as shown in FIG. 6, the online system 140 retrieves 320 a table 600 of conversion data from the action log 220 including information identifying a type of action comprising a conversion performed by an individual (e.g., a conversion type identifier 615), a content item associated with the conversion (e.g., a content item identifier 405, 605) which corresponds to the content item identified by the presentation data, an online system user associated with the content item (e.g., a publishing user identifier 610) and a time each conversion was performed (e.g., a time stamp 415, 620).

The conversion data also includes information describing conversion features 625 associated with each conversion and user identifying information (e.g., an online system user identifier 425, 630) associated with a plurality of individuals who performed the conversion. Conversion features 625 included in the conversion data identify values of attributes associated with each occurrence of a conversion. In various embodiments, the conversion features 625 identify values describing a web browser on which a conversion occurred, a privacy setting associated with the web browser, a client device 110 on which the conversion occurred, and/or an operating system executing on the client device 110. For example, if an individual performed a conversion (e.g., completed an online purchase associated with the content item) on a Chrome web browser associated with a low privacy cookie setting, and the web browser was operating on a Sony Vaio laptop computer executing a Windows 10 operating system, the conversion data includes conversion features 625 identifying values of Chrome, low privacy, Sony, Vaio, laptop, and/or Windows 10.

In the example of FIG. 6, conversion features 625 included in the table 600 of conversion data identify values describing client devices 110 on which individuals performed a conversion, browsers on which the individuals performed the conversion, and operating systems executing on the client devices 110. For example, a conversion feature 625 describing a client device 110 on which a conversion was performed identifies a value of laptop computer, desktop computer, mobile phone, or tablet. Although the value in the previous example identifies a type of client device 110, in other embodiments, the value may alternatively or additionally identify a brand of the client device 110 (e.g., Apple, Sony, Samsung, etc.) or a model of the client device 110 (e.g., iPhone, Vaio, Galaxy, etc.). As another example, a conversion feature 625 describing a browser on which a conversion was performed identifies a value of Safari, Chrome, Firefox, or MS Edge. Additionally, in this example, a conversion feature 625 describing an operating system executing on a client device 110 on which a conversion was performed identifies a value of Mac OS, Android, or Windows.

Conversion data retrieved 320 by the online system 140 also includes user identifying information associated with some of the individuals who performed a conversion described by the conversion data. As previously described, user identifying information is information used by the online system 140 to identify an individual associated with the user identifying information or to distinguish the individual from individuals not associated with the user identifying information, such as individuals associated with different or no user identifying information. The user identifying information described by the conversion data includes one or more of an online system user identifier 425, 630, a client device identifier, an application identifier, a browser identifier, and any other suitable information from which the online system 140 may identify or distinguish an individual associated with a client device 110 on which a conversion was performed. In various embodiments, the online system 140 identifies or distinguishes individuals who performed a conversion to generate a metric describing a number of individuals who performed the conversion. For example, if every conversion described by the conversion data is associated with a client device identifier, the online system 140 may estimate a number of individuals who performed the conversion by computing a number of unique client device identifiers included in the conversion data. In this example, the number of unique client device identifiers included in the conversion data corresponds to an estimated number of individuals who performed a conversion, which may be a different number than the number of conversions described by the conversion data (e.g., due to performance of multiple conversions by a single individual on multiple client devices 110).

However, as illustrated in the example of FIG. 6, while the conversion data includes user identifying information associated with some individuals who performed a conversion, user identifying information is not associated with every conversion described by the conversion data. For example, the conversion data may include online system user identifiers 425, 630 associated with individuals who were logged into the online system 140 when performing a conversion, but not include online system user identifiers 425, 630 associated with individuals who were not logged into the online system 140 when performing a conversion. If the conversion data describes one or more conversions not associated with user identifying information, the online system 140 may be unable to distinguish between multiple conversions performed by a single individual and multiple conversions performed by multiple individuals. For example, while the conversion data in FIG. 6 describes at least two conversions performed by an individual associated with the online system user identifier 425, 630 “DdeeFf522” and single conversions performed by each other individual associated with an online system user identifier 425, 630, it is unclear from the conversion data whether multiple conversions not associated with user identifying information correspond to conversions performed by a single individual or by multiple individuals. Hence, the number of individuals who performed a conversion may be different than the number of conversions described by the conversion data.

To identify conversion data describing conversions performed by a unique group of individuals (e.g., to determine a number of individuals who performed a conversion), the online system 140 determines 330 an additional group of individuals who performed a conversion based on a set of conversion features 625 and user identifying information included in the conversion data. For example, the online system 140 predicts a composition of an additional group of individuals associated with a set of the conversion data such that each individual member of the additional group of individuals is a unique individual who performed a conversion.

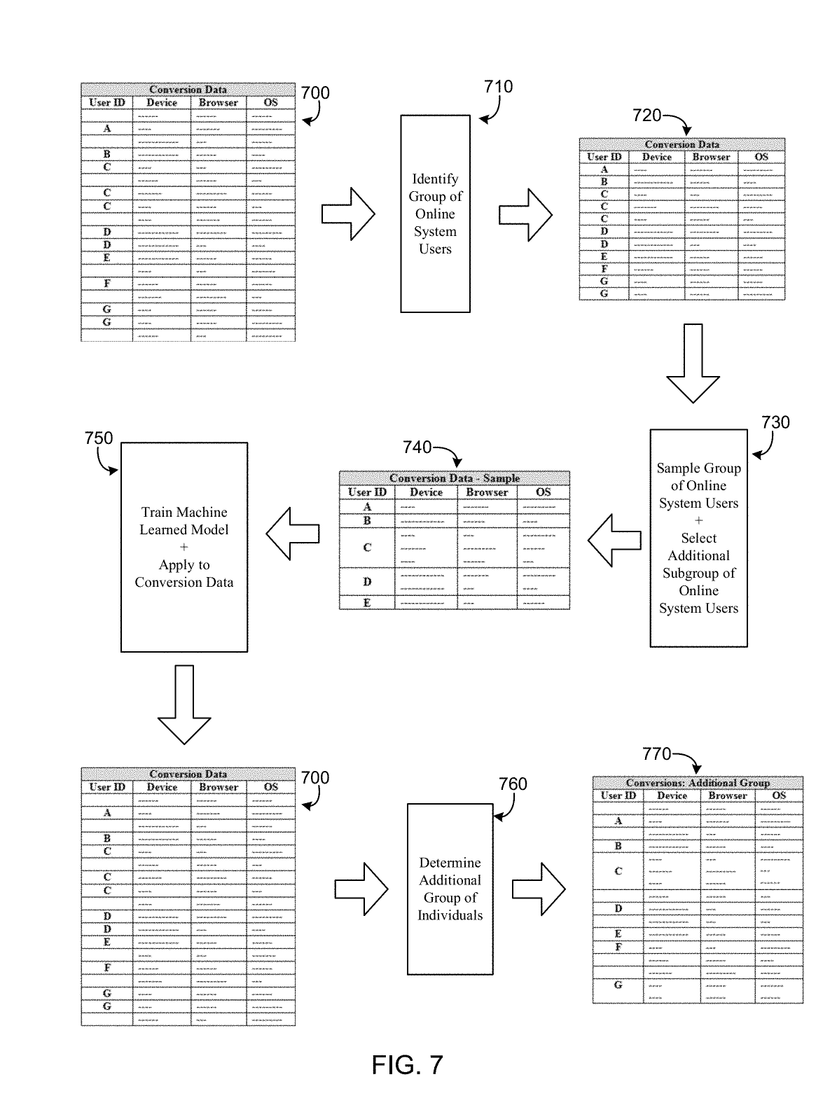

To determine 330 the additional group of individuals, the online system 140 identifies a group of online system users associated with user identifying information included in the retrieved conversion data. For example, referring to FIG. 7, the online system 140 identifies 710 a group of seven online system users associated with online system user identifiers 425, 630 (“A” through “G”) and a set 720 of the conversion data 700. The online system 140 samples 730 the identified group of online system users and selects 730 an additional subgroup of online system users having at least a threshold measure of similarity to a plurality of individuals who performed a conversion described by the conversion data 700. For example, the online system 140 selects 730 an additional subgroup of online system users associated with a frequency distribution of conversion feature values described by the conversion data 700. Thus, in the preceding example, if conversion feature values described by the conversion data 700 indicate a percentage of the conversions occurring on a laptop computer, a desktop computer and a smart phone are 66%, 22% and 12%, the online system 140 selects 730 a subgroup of users for which approximately 66%, 22% and 12% of conversions performed by members of the additional subgroup occurred on a laptop computer, a desktop computer and a smart phone. In various embodiments, the online system 140 may use one or more alternative methods of sampling to select 730 the additional subgroup of users from the identified group of users. For example, the online system 140 may use one or more sampling methods including a random sampling technique, a systematic sampling technique, a stratified sampling technique, and a cluster sampling technique.

The online system 140 identifies a set 740 of conversion feature values associated with each user of the additional subgroup of users and uses the set 740 of conversion feature values to train 750 a machine learned model (a “conversion model”) used by the online system 140 to determine 330, 760 the additional group of individuals who performed a conversion associated with the content item. In various embodiments, the machine learning module 230 of the online system 140 uses one or more machine learning techniques to determine associations between each value of the set 740 of conversion feature values associated with the additional subgroup of users and to generate weights for each value and/or different combinations of values. For example, the machine learning techniques may include a classification technique, a clustering technique, a decision tree learning technique, a random forest technique, a logistic regression technique, a linear regression technique, and a gradient boosting technique.

Two or more conversion feature values are associated with each other if the values are associated with the same user of the additional subgroup of users. Weights generated by the machine learning module 230 and included in the conversion model describe a strength of the determined associations between each conversion feature value or combination of values included in the set 740 of conversion feature values associated with the additional subgroup of users. For example, a weight generated for a particular combination of conversion feature values is proportional to a determined probability that the values are associated based on an identified frequency of the combination of values included in the set 740 of conversion feature values associated with the additional subgroup of users.

Based on a strength of the determined associations between each conversion feature value or each combination of values, the conversion model predicts a likelihood that conversions associated with certain combinations of the values are associated with a single unique individual. For example, if a weight of 0.8 is generated for a combination of conversion feature values determined to be strongly associated with each other, the conversion model predicts that, for every ten occurrences of the combination of values in the conversion data 700, eight unique individuals performed a conversion associated with the content item. As another example, if the machine learning module 230 generates a weight of 0.45 for a combination of conversion feature values determined to be moderately associated, the conversion model predicts that 45% of occurrences of the combination of values included in the conversion data 700 are associated with a single unique individual who performed a conversion.

In the example of FIG. 7, the machine learning module 230 generates weights for each conversion feature value (e.g., device, browser and operating system) and for different combinations of conversion feature values (e.g., device and browser, device and operating system, and browser and operating system) based on a frequency distribution of each value and combination of values included in the set 740 of conversion feature values associated with the additional subgroup of users. Weights describing strong associations between certain combinations of the values correspond with a high probability that multiple conversions associated with the combinations were performed by a single unique individual. For example, the machine learning module 230 generates a weight of 0.9 for a particular combination of conversion feature values if a probability that the combination of conversion feature values is associated with a single unique individual is at least 90%. In the preceding example, the machine learning module 230 may generate the weight of 0.9 based on a determination that at least nine out of every ten users of the additional subgroup of users associated with two or more conversion feature values of a combination of five conversion feature values are also associated with two or more other conversion feature values of the combination of values.

The online system 140 applies 750 the trained conversion model to values of the conversion features 625 described by the retrieved conversion data 700. In one embodiment, the conversion model is configured to receive, as input, information identifying the content item, a publishing user associated with the content item, a type of conversion associated with the content item and values of conversion features 625 included in the conversion data 700. Based on the input, the conversion model predicts a likelihood that certain combinations of the conversion feature values are associated with unique individuals who performed a conversion and extrapolates a number of unique individuals associated with each combination. For example, weights generated for different combinations of conversion feature values are applied to a number of occurrences of each combination of the values in the conversion data 700 to predict a number of unique individuals associated with each combination and, conversely, a plurality of conversion feature values associated with each unique individual. Based on the extrapolated number of unique individuals associated with each combination of the conversion feature values and the conversion feature values associated with each unique individual, the online system 140 determines 330,760 the additional group of individuals who performed a conversion and a plurality of conversion feature values associated with the additional group of individuals 770.

In various embodiments, the online system 140 generates one or more metrics describing the additional group of individuals and provides the metric to an entity or user of the online system 140 associated with the content item. For example, the online system 140 generates a metric describing a number of individuals who performed a conversion associated with the content item and provides the metric to a publishing user associated with the content item in response to receiving a request from the user for a metric describing the conversions. In the previous example, the number of individuals who performed a conversion corresponds to the number of predicted unique individuals in the determined additional group of individuals, which may differ from the number conversions described by the conversion data 700. Hence, application of the conversions model to the conversion data 700 allows the online system 140 to determine 330, 760 a group of identifiable and non-identifiable individuals who performed a conversion associated with the content item and to determine metrics describing the conversions.

In various embodiments, the online system 140 determines metrics describing an amount of individuals who performed a conversion attributable to presentation of the content item by a content publisher based in part on presentation data associated with the group of individuals and conversion data associated with the additional group of individuals. To predict an amount of individuals who performed a conversion attributable to presentation of the content item by the content publisher, the online system 140 identifies 340 users who were presented with the content item by the content publisher and who performed a conversion based on the user identifying information included in the presentation data associated with the group of individuals and the conversion data associated with the additional group of individuals. For example, the online system 140 matches a user identifier included in the presentation data and a user identifier included in the conversion data to determine a user associated with the user identifier was presented with the content item and performed a conversion associated with the content item.

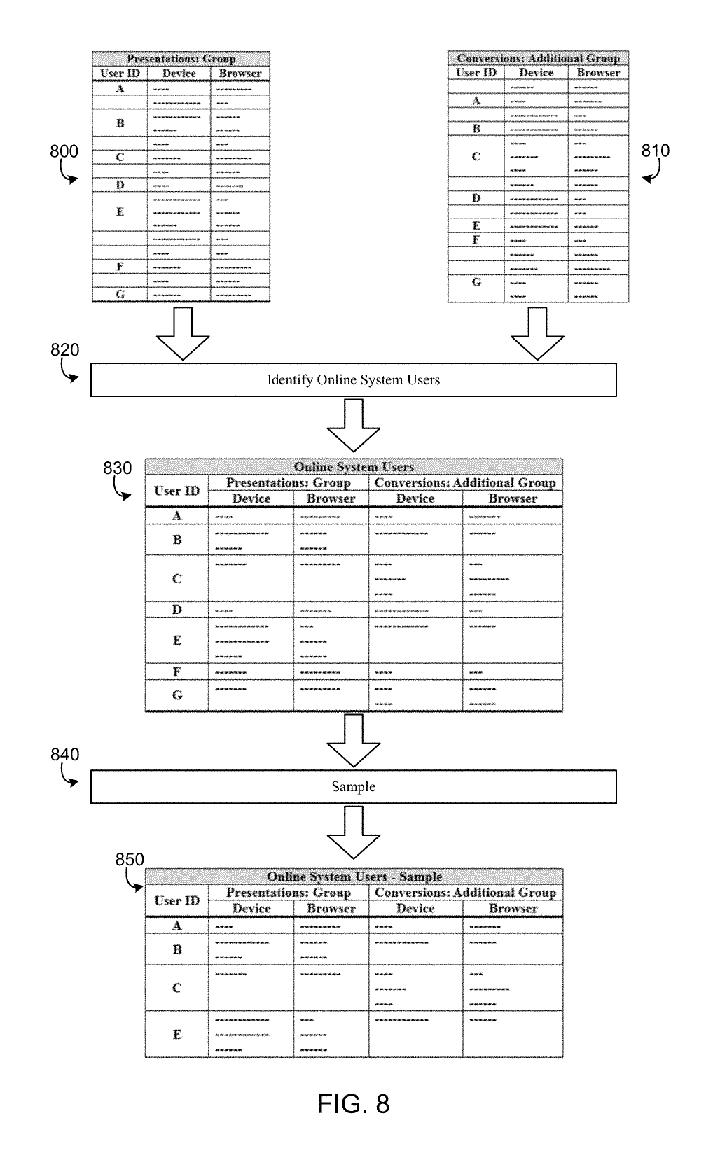

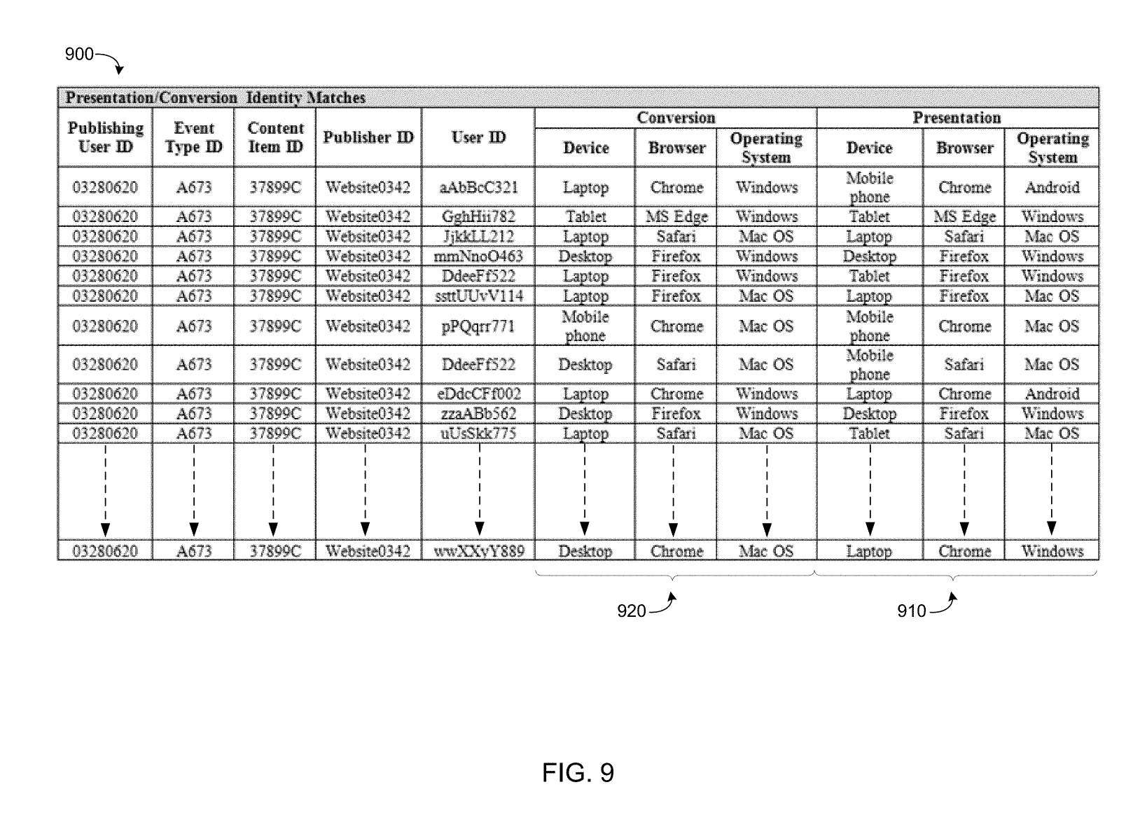

In the example of FIG. 8, the online system 140 collects presentation data 800 describing presentation of the content item to the group of individuals and conversion data 810 describing conversions performed by the additional group of individuals and identifies 340, 820 seven online system users associated with user identifying information included in the presentation data 810 and conversion data 820. In this example, the identified online system users are associated with online system user identifiers 425, 630 “A” through “G.” As shown in this example, each identified user is associated with a plurality 830 of presentation feature values and conversions feature values. In various embodiments, the online system 140 compiles data describing the plurality 830 of presentation feature values and conversion feature values associated with each identified user. For example, referring to FIG. 9, the compiled data 900 includes information identifying the content item, a publishing user of the online system 140 associated with the content item, a content publisher that presented the content item, user identifying information associated with users who were presented with the content item, a type of conversion performed by the users, presentation feature values 910 associated with each presentation of the content item and conversion feature values 920 associated with each conversion.

Referring back to FIG. 8, the online system 140 samples 840 the identified online system users based on the plurality 830 of presentation feature values 910 and conversions feature values 920 associated with the users and selects 350 a set of the users as a representative sample of the group and additional group of individuals based on the sampling. In this example, the online system 140 selects 350 a set of online system users associated with the online system user identifiers 425, 630 “A” through “E.” As illustrated, each user of the set of users is associated with a set 850 of presentation feature values 910 and conversions feature values 920. In some embodiments, the online system 140 selects 350 a set of users associated with a set 850 of presentation feature values 910 and conversion feature values 920 having a frequency distribution approximating a frequency distribution of presentation feature values 910 included in the presentation data 810 associated with the group of individuals and conversion feature values 920 included in the conversion data 820 associated with the additional group of individuals. For example, if the frequency distribution of a type of client device 110 on which the content item was presented to the group of individuals is 65% smart phone, 30% tablet and 5% laptop, and the frequency distribution of a type of browser on which a conversion was performed by the additional group of individuals is 55% Firefox, 35% Chrome and 10% Safari, the online system 140 selects 350 a set of users having a frequency distribution of a type of client device 110 on which the content item was presented and a type of browser on which a conversion was performed approximating 65% smart phone, 30% tablet, 5% laptop, 55% Firefox, 35% Chrome and 10% Safari.

In some embodiments, the online system 140 uses one or more alternative methods of sampling to select 350 the sample set of users. For example, the online system 140 uses one or more sampling methods including a random sampling technique, a systematic sampling technique, a stratified sampling technique, and a cluster sampling technique. Hence, the online system 140 selects 350 a set of identifiable online system users who were presented with the content item by the content publisher and who performed a conversion associated with the content item as a representative sample of all identifiable and non-identifiable individuals associated with the presentation data 810 and the conversion data 820.

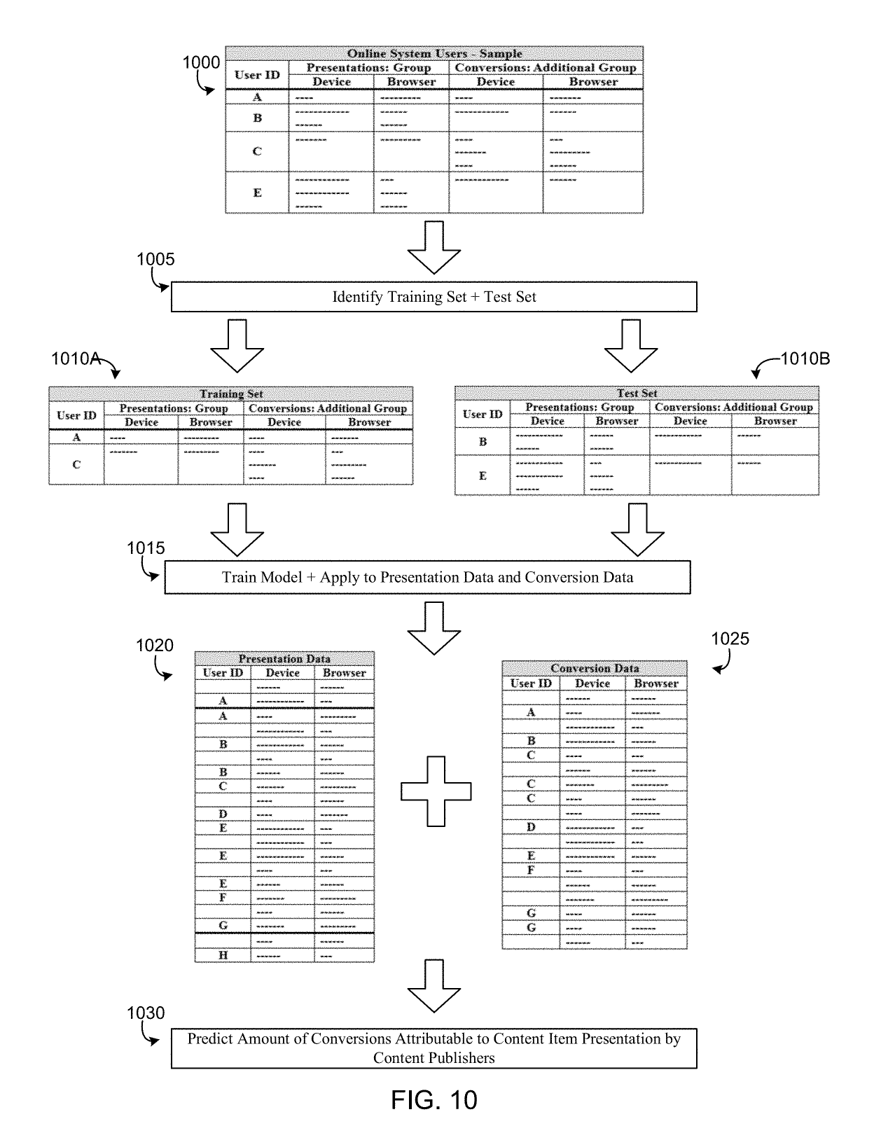

From the set 850 of presentation feature values 910 and conversion feature values 920 associated with the set of users, the online system 140 identifies 360 a set of training data and uses the training data to train 370 a machine learned model (an “attribution model”) to predict an amount of conversions attributable to presentation of the content item by the content publisher. For example, referring to FIG. 10, the online system 140 identifies 360, 1005 a set of training data 1010A-B comprising a training set 1010A and test set 1010B of presentation feature values 910 and conversion feature values 920 from a set 1000 of presentation feature values 910 and conversion feature values 920 associated with the set of users. One or more conversion feature values 920 is associated with one or more presentation future values 910 if the values 910, 920 are associated with the same user. In various embodiments, one or more machine learning techniques are used by the online system 140 to train 370, 1015 the attribution model to determine associations between one or more presentation feature values 910 and one or more conversion feature values 920 included in the set of training data 1010A-B and to generate weights for each value 910, 920 or different combinations of values 910, 920. The machine learning techniques may include one or more of a classification technique, a clustering technique, a decision tree learning technique, a random forest technique, a logistic regression technique, a linear regression technique, and a gradient boosting technique, in various embodiments.

In various embodiments, weights generated by the machine learning module 230 and included in the attribution model describe a strength of the determined associations between each presentation feature value 910 and conversion feature value 920 associated with the set of users (e.g., based on a frequency of the associations in the training data 1010A-B). Additionally, or alternatively, the generated weights describe a strength of determined associations between different combinations of the presentation feature values 910 and conversion feature values 920. In one embodiment, a magnitude of a numerical weight generated for a particular combination of presentation feature values 910 and conversion feature values 920 is proportional to a strength of the determined association between the values 910, 920. For example, if 80% of conversions associated with a particular combination of conversion feature values 920 are also associated with a particular combination of presentation feature values 910, the weight generated for the combination of presentation feature values 910 and conversion feature values 920 is 0.8. In the preceding example, 80% of the conversions associated with the particular combination of conversion feature values 920 were performed by users associated with the particular combination of presentation feature values 910.

Based on the generated weights, the attribution model predicts a likelihood that certain combinations of conversion feature values 920 are associated with certain combinations of presentation feature values 910 and are therefore also associated with a single individual. Based on the predicted likelihoods, the attribution model extrapolates a number of unique individuals associated with the combined values 910, 920. For example, if a weight of 0.9 is generated for a combination of presentation feature values 910 and conversion feature values 920 determined to be strongly associated, the attribution model predicts that, for every ten occurrences of the combination of values 910, 920 in the presentation data and conversion data, nine unique individuals were presented with the content item by the content publisher and performed a conversion. As another example, if the machine learning module 230 generates a weight of 0.1 for a combination of presentation feature values 910 and conversion feature values 920 determined to be weakly associated, the attribution model predicts that 10% of occurrences of the combination of values 910, 920 in the presentation data and conversion data are associated with a unique individual who was presented with the content item by the content publisher and performed a conversion.

In various embodiments, the online system 140 applies 1015 the attribution model to collected presentation data 1020 and conversion data 1025 to predict an amount of conversions attributable to presentation of the content item by a plurality of content publishers. For example, the attribution model is configured to receive, as input, information about the content item, a content publisher that presented the content item, an online system user associated with the content item, a combination of presentation feature values 910, and a combination of conversion feature values 920. Based on the input, the attribution model predicts a likelihood that the combination of presentation feature values 910 and conversion feature values 920 is associated with one or more unique individuals and extrapolates a number of unique individuals associated with the combination. Based on the extrapolated number of unique individuals associated with different combinations of presentation feature values 910 and conversion feature values 920 in the collected data 1020, 1025, the online system 140 predicts 1030 an amount of individuals presented with the content item who performed a conversion. For example, a predicted amount of individuals presented with the content item who performed a conversion corresponds to an amount of unique individuals predicted to be associated with the combinations of presentation feature values 910 and conversion feature values 920 included in the presentation data 1020 and conversion data 1025.

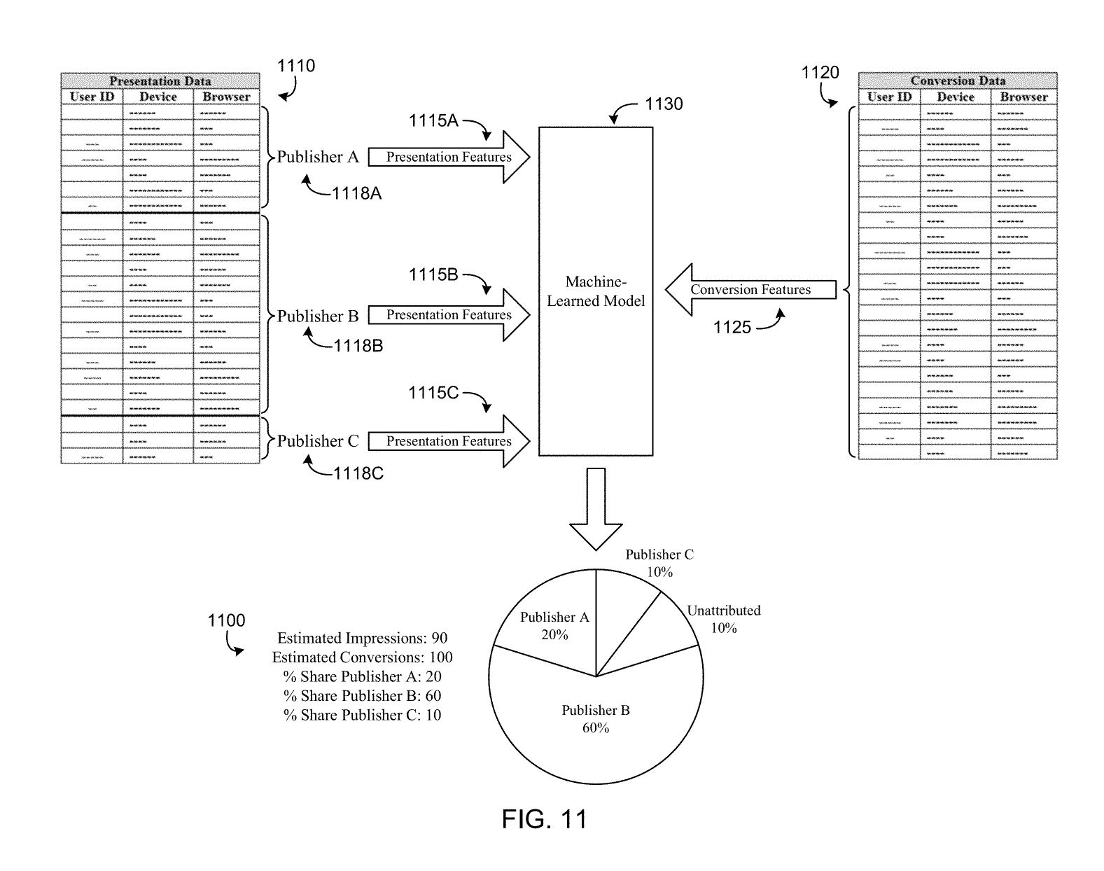

In various embodiments, the online system 140 generates a metric describing an amount of conversions attributable to presentation of the content item by one or more of the plurality of content publishers based on predictions made by the attribution model. For example, as illustrated in FIG. 11, the online system 140 generates a metric 1100 describing each content publisher's share of attribution for conversions based on a predicted amount of conversions attributable to presentation of the content item by each content publisher. In various embodiments, the online system 140 determines a particular content publisher's percentage share of attribution based on a ratio of a predicted number of unique individuals who performed a conversion in response to being presented with the content item by the content publisher to the total predicted number of conversions performed by unique individuals.

In the example of FIG. 11, the online system 140 applies 1015 the attribution model 1130 to presentation feature values 910, 1115A-C and conversion feature values 920, 1125 included in presentation data 1010, 1110 and conversion data 1020, 1120 collected by the online system 140. The attribution model 1130 predicts 1030 a number of conversions performed by unique individuals in response to being presented with a content item by each of a plurality of content publishers 1118A-C. In this example, the online system 140 determines each content publisher's 1118A-C percentage share of attribution for the conversions by computing a ratio of the predicted number of conversions performed by individuals associated with presentation feature values 910 describing presentation of the content item by a particular content publisher 1118A-C to the total predicted number of conversions performed by unique individuals. The metric 1100 may be provided to a user associated with the content item so the user may use the metric to determine effectiveness of each content publisher's 1118A-C presentation of the content item for eliciting conversions. Hence, application of the attribution model 1130 to collected data allows the online system 140 to predict 1030 an amount of identifiable and non-identifiable individuals who performed a conversion attributable to presentation of a content item by a plurality of content publishers 1118A-C and determine a metric describing an amount of the conversions attributable to presentation of the content item by each content publisher 1118A-C.

### SUMMARY

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving presentation data describing presentation of a content item to a plurality of individuals by a plurality of content publishers, the presentation data comprising a plurality of presentation features associated with presentation of the content item to each individual of the plurality of individuals and user identifying information associated with one or more users of an online system;
determining a group of individuals presented with the content item by a content publisher of the plurality of content publishers based at least in part on the plurality of presentation features;
retrieving conversion data describing occurrences of an event associated with the content item, the conversion data comprising a plurality of conversion features associated with each occurrence of the event and the user identifying information associated with the one or more users of the online system;
determining an additional group of individuals associated with the event based at least in part on the plurality of conversion features;
identifying, from the group of individuals and the additional group of individuals, a plurality of users of the online system who are members of the group and the additional group based on the user identifying information included in the presentation data and the conversion data;
selecting, from the plurality of users, a set of users based at least in part on the group of individuals and the additional group of individuals;
identifying a set of training data comprising one or more values associated with a set of presentation features and a set of conversion features associated with each user of the set of users; and
training a machine-learned model using the training data, the machine-learned model extrapolating an amount of occurrences of the event attributable to presentation of the content item to the group of individuals by the content publisher.

2. The method of claim 1, wherein determining the group of individuals presented with the content item based at least in part on the plurality of presentation features comprises:
identifying, from the plurality of individuals, a group of users of the online system based on the user identifying information included in the presentation data;
selecting, from the group of users, a subgroup of users having at least a threshold measure of similarity to the plurality of individuals;
identifying a training data set comprising one or more values associated with a set of presentation features associated with each user of the subgroup of users; and
training an additional machine-learned model using the training data set, the additional machine-learned model determining the group of individuals presented with the content item by the content publisher.

3. The method of claim 1, wherein determining the additional group of individuals associated with the event based at least in part on the plurality of conversion features comprises:
identifying, from an additional plurality of individuals associated with the event, a group of users of the online system based on the user identifying information included in the conversion data;
selecting, from the group of users, a subgroup of users having at least a threshold measure of similarity to the additional plurality of individuals;
identifying a training data set comprising one or more values associated with a set of conversion features associated with each user of the subgroup of users; and
training an additional machine-learned model using the training data set, the additional machine-learned model determining the additional group of individuals associated with the event.

4. The method of claim 1, wherein selecting the set of users based at least in part on the group of individuals and the additional group of individuals comprises:
determining a first distribution of presentation feature values associated with the group of individuals and a second distribution of conversion feature values associated with the additional group of individuals; and
selecting a set of users associated with a distribution of presentation feature values having at least a threshold measure of similarity to the first distribution and an additional distribution of conversion feature values having at least a threshold measure of similarity to the second distribution.

5. The method of claim 1, wherein the plurality of presentation features describe one or more selected from a group consisting of: a web browser on which the content item was presented to an individual of the plurality of individuals, a privacy setting associated with the web browser, a client device on which the content item was presented to the individual, an operating system operating on the client device, and any combination thereof.

6. The method of claim 1, wherein the plurality of conversion features describe one or more selected from a group consisting of: a web browser on which the event associated with the content item occurred, a privacy setting associated with the web browser, a client device on which the event occurred, an operating system operating on the client device, and any combination thereof.

7. The method of claim 1, wherein extrapolating an amount of occurrences of the event attributable to presentation of the content item by the content publisher comprises:
computing, by the machine-learned model, a weight associated with a presentation feature of the set of presentation features and a conversion feature of the set of conversion features based at least in part on an amount of users of the set of users associated with the presentation feature and the conversion feature;
determining a set of individuals associated with the presentation feature and the conversion feature;
applying the weight to an amount of individuals of the set of individuals; and
extrapolating a percentage of occurrences of the event attributable to presentation of the content item by the content publisher based at least in part on the applying the weight.

8. The method of claim 1, wherein the amount of occurrences of the event comprises a percentage of the occurrences attributable to presentation of the content item to the group of individuals by the content publisher.

9. The method of claim 1, further comprising:
determining a metric describing performance of the content item based in part on an extrapolated amount of occurrences of the event attributable to presentation of the content item to the group of individuals by the content publisher; and
providing the performance metric to a user of the online system associated with the content item.

10. The method of claim 1, wherein the training data describes an association between at least one presentation feature of the set of presentation features and at least one conversion feature of the set of conversion features.

11. The method of claim 1, wherein the machine-learned model is configured to receive as input one or more values associated with the content item and one or more values associated with the content publisher.

12. The method of claim 1, wherein the machine-learned model is based on one or more selected from a group consisting of: a linear regression, a logistic regression, a boosting tree, a weighted decision tree, and any combination thereof.

13. The method of claim 1, wherein selecting the set of users is further based at least in part on one or more sampling techniques selected from a group consisting of: a random sampling technique, a systematic sampling technique, a stratified sampling technique, a cluster sampling technique, and any combination thereof.

14. The method of claim 1, wherein the user identifying information includes one or more selected from a group consisting of: an online system user identifier, a client device identifier, a browser identifier, and any combination thereof.

15. The method of claim 1, wherein the one or more events associated with the content item are selected from a group consisting of: a visit by an individual of the additional group of individuals to a website associated with the content item, a visit by the individual to a physical location associated with the content item, a purchase by the individual of a product associated with the content item, a purchase by the individual of a service associated with the content item, and any combination thereof.

16. A method comprising:
receiving presentation data describing presentation of a content item to a group of individuals by a content publisher, the presentation data comprising a plurality of presentation features associated with the group of individuals and user identifying information associated with one or more users of an online system;
retrieving conversion data describing performance of an action associated with the content item by an additional group of individuals, the conversion data comprising a plurality of conversion features associated with the additional group of individuals and the user identifying information associated with the one or more users of the online system;
identifying, from the group of individuals and the additional group of individuals, a set of users of the online system based on the user identifying information, the set of users having at least a threshold similarity to the group of individuals and the additional group of individuals;
identifying a set of presentation features and a set of conversion features associated with each user of the set of users; and
using one or more values associated with the set of presentation features and the set of conversion features to train a machine-learned model to extrapolate an amount of actions performed by the additional group of individuals attributable to presentation of the content item to the group of individuals.

17. A computer program product comprising a computer readable storage medium having instructions encoded thereon that, when executed by a processor, cause the processor to:
receive presentation data describing presentation of a content item to a plurality of individuals by a plurality of content publishers, the presentation data comprising a plurality of presentation features associated with presentation of the content item to each individual of the plurality of individuals and user identifying information associated with one or more users of an online system;
determine a group of individuals presented with the content item by a content publisher of the plurality of content publishers based at least in part on the plurality of presentation features;
retrieve conversion data describing occurrences of an event associated with the content item, the conversion data comprising a plurality of conversion features associated with each occurrence of the event and the user identifying information associated with the one or more users of the online system;
determine an additional group of individuals associated with the event based at least in part on the plurality of conversion features;
identify, from the group of individuals and the additional group of individuals, a plurality of users of the online system who are members of the group and the additional group based on the user identifying information included in the presentation data and the conversion data;
select, from the plurality of users, a set of users based on the group of individuals and the additional group of individuals;
identify a set of training data comprising one or more values associated with a set of presentation features and a set of conversion features associated with each user of the set of users; and
train a machine-learned model using the training data, the machine-learned model extrapolating an amount of occurrences of the event attributable to presentation of the content item to the group of individuals by the content publisher.

18. The computer program product of claim 17, wherein determine the group of individuals presented with the content item based at least in part on the plurality of presentation features comprises:
identify, from the plurality of individuals, a group of users of the online system based on the user identifying information included in the presentation data;
select, from the group of users, a subgroup of users having at least a threshold measure of similarity to the plurality of individuals;
identify a training data set comprising one or more values associated with a set of presentation features associated with each user of the subgroup of users; and
train an additional machine-learned model using the training data set, the additional machine-learned model determining the group of individuals presented with the content item by the content publisher.

19. The computer program product of claim 17, wherein determine the additional group of individuals associated with the event based at least in part on the plurality of conversion features comprises:
identify, from an additional plurality of individuals associated with the event, a group of users of the online system based on the user identifying information included in the conversion data;
select, from the group of users, a subgroup of users having at least a threshold measure of similarity to the additional plurality of individuals;
identify a training data set comprising one or more values associated with a set of conversion features associated with each user of the subgroup of users; and
train an additional machine-learned model using the training data set, the additional machine-learned model determining the additional group of individuals associated with the event.

20. The computer program product of claim 17, wherein select the set of users based at least in part on the group of individuals and the additional group of individuals comprises:
determine a first distribution of presentation feature values associated with the group of individuals and a second distribution of conversion feature values associated with the additional group of individuals; and
select a set of users associated with a distribution of presentation feature values having at least a threshold measure of similarity to the first distribution and an additional distribution of conversion feature values having at least a threshold measure of similarity to the second distribution.

21. The computer program product of claim 17, wherein the plurality of presentation features describe one or more selected from a group consisting of: a web browser on which the content item was presented to an individual of the plurality of individuals, a privacy setting associated with the web browser, a client device on which the content item was presented to the individual, an operating system operating on the client device, and any combination thereof.

22. The computer program product of claim 17, wherein the plurality of conversion features describe one or more selected from a group consisting of: a web browser on which the event associated with the content item occurred, a privacy setting associated with the web browser, a client device on which the event occurred, an operating system operating on the client device, and any combination thereof.

23. The computer program product of claim 17, wherein extrapolate an amount of occurrences of the event attributable to presentation of the content item by the content publisher comprises:
compute, by the machine-learned model, a weight associated with a presentation feature of the set of presentation features and a conversion feature of the set of conversion features based at least in part on an amount of users of the set of users associated with the presentation feature and the conversion feature;
determine a set of individuals associated with the presentation feature and the conversion feature;
apply the weight to an amount of individuals of the set of individuals; and
extrapolate a percentage of occurrences of the event attributable to presentation of the content item by the content publisher based at least in part on the applying the weight.

24. The computer program product of claim 17, wherein the amount of occurrences of the event comprises a percentage of the occurrences attributable to presentation of the content item to the group of individuals by the content publisher.

25. The computer program product of claim 17, wherein the computer readable storage medium further has instructions encoded thereon that, when executed by the processor, cause the processor to:
determine a metric describing performance of the content item based in part on an extrapolated amount of occurrences of the event attributable to presentation of the content item to the group of individuals by the content publisher; and
provide the performance metric to a user of the online system associated with the content item.

26. The computer program product of claim 17, wherein the training data describes an association between at least one presentation feature of the set of presentation features and at least one conversion feature of the set of conversion features.

27. The computer program product of claim 17, wherein the machine-learned model is configured to receive as input one or more values associated with the content item and one or more values associated with the content publisher.

28. The computer program product of claim 17, wherein the machine-learned model is based on one or more selected from a group consisting of: a linear regression, a logistic regression, a boosting tree, a weighted decision tree, and any combination thereof.

29. The computer program product of claim 17, wherein select the set of users is further based at least in part on one or more sampling techniques selected from a group consisting of: a random sampling technique, a systematic sampling technique, a stratified sampling technique, a cluster sampling technique, and any combination thereof.

30. The computer program product of claim 17, wherein the user identifying information includes one or more selected from a group consisting of: an online system user identifier, a client device identifier, a browser identifier, and any combination thereof.

31. The computer program product of claim 17, wherein the one or more events associated with the content item are selected from a group consisting of: a visit by an individual of the additional group of individuals to a website associated with the content item, a visit by the individual to a physical location associated with the content item, a purchase by the individual of a product associated with the content item, a purchase by the individual of a service associated with the content item, and any combination thereof.
